(19) United States
(12) Patent Application Publication
(10) Pub. No.: US 2007/0029793 A1
(43) Pub. Date: Feb. 8, 2007

(54) Method and apparatus for protecting conduits

(76) Inventors: Kevin Douglas, Ann Arbor, MI (US); Frank Rampton, Ann Arbor, MI (US); Charles Kennedy, Ann Arbor, MI (US)

Correspondence Address: DOBRUSIN & THENNISCH PC, 29 W LAWRENCE ST, SUITE 210, PONTIAC, MI, 48326, US

(21) Appl. No.: 11/255,286

(22) Filed: Oct. 20, 2005

Related U.S. Application Data
(60) Provisional application No. 60/620,300, filed on Oct. 20, 2004.

(51) Int. Cl. F16L 55/00

(52) U.S. Cl. 285/45

(57) ABSTRACT

The present invention provides a system and method of protecting underground utility pipes and fixtures attached thereto from corrosion and shifting earth, wherein the system includes an enclosure adapted to enclose a pipe portion and fixture and which is adapted to receive or house material to provide corrosion protection to the pipe portion and fixture.

### CLAIM OF PRIORITY

To the extent applicable, the present invention claims the benefit of the priority of U.S. Provisional Application Ser. No. 60/620,300, filed Oct. 20, 2004, the contents of which are incorporated by reference herein.

### FIELD OF THE INVENTION

The present invention relates generally to a method and apparatus for the protection of underground pipe portions and attached fittings from corrosion, earth shifting or otherwise.

BACKGROUND

Numerous industries utilize conduits for transferring, distribution or protection of materials over a distance, either great or small. While numerous conduits are available, one particularly useful conduit comprises pipe members, which can be linkably attached. Examples of products that may be transferred, distributed or housed within pipe portions include, but are not limited to, fluid materials such as: natural gas, propane, water, petroleum, industrial products, paper making material, chemicals, waste product, nuclear product or byproduct, food product, air and other fluids. However, non-fluid materials may also be advantageously housed within pipe portion such as: electrical wire, cable wire, or the like.

In any case, it may be desirous to provide protection to these pipe portion and fixtures attached thereto from damaging condition as discussed herein or otherwise. Also, it may be desirous to seal these pipe portions and fixtures from the surrounding environment, or alternatively seal low pressure fluid leaks from the pipe portion or fixture.

In one non exclusive exemplary field, natural gas may be delivered through a network, via pressurized gas, to different localities of a service region. From these main gas lines, branches extend to further supply more specific areas (e.g., blocks, subdivisions, business sector or otherwise), which may further branch to feed individual homes, business or otherwise with natural gas.

In connecting these pipe members, a fixture such, as a valve, to join the supply line and optionally provide control of the flow of natural gas. Advantageously, this ability allows the supply company to control the flow of natural gas to these places, which is particularly desired during repair, alteration or removal of a gas line from the supply system. This is also desired during emergencies such as failure of the natural gas line (e.g., due line breakage, fire or otherwise).

Due to the continual required access to these pipe portions and fixtures, utility companies are required to excavate large portions of earth in order gain access to these components. This type of excavation results in the formation of ditches, craters, holes or otherwise so as to allow individuals to physically climb down to where the pipe portions and fixtures are located. This type of excavating process requires the use of heavy equipment (e.g., diggers, excavators, etc.) to remove substantial amount of dirt, concrete or otherwise. Not only is this method time consuming and costly, due in part to the purchase and upkeep of this equipment, but it is also inconvenient for surrounding homes and business who must tolerate the noise, road conditions and obstacles resulting therefrom.

In response to the above excavation inconveniences, industries have responded with the use of keyhole technology, which has been found to be cost effective. Keyhole technology is the accessing of underground equipment by creating small and substantially vertical holes over these pipe portions and fixtures, thereby forming generally a cylindrical-shaped hole having substantially vertical walls. Typically, these holes are small wherein a person would not be able to safely access the underground pipes without the use of tools. Examples of Keyhole forming tools includes drills, hydro cutting/digging tools, siphoning mechanism or otherwise.

Upon completion of work the pipe portions and/or valve assembly are left without sufficient coating for protection from damage resulting from corrosion, earth shifting or otherwise. As such, the application of an additional layer of coating or otherwise is often required to provide some level of protection.

In the past, attempts have been made to protect these pipes by coating the pipe portion and valve assembly with anti-corrosion agents or wrap. However, the application of these protective measures have proven challenging due to the space constraints within a keyhole.

Given the lack of protection of above and below ground conduits, specifically natural gas, there is a need for a system, method and tools for the protection of underground pipe portions and fixtures from corrosion and shifting earth. More so, there is a need for a system, which also protects pipes and fixtures from corrosion, or otherwise, as a result of the surrounding environment, which can be installed in cylindrically formed using keyhole technology.

### SUMMARY OF THE INVENTION

The present invention provides a method and apparatus for the protection of pipe members and valve assemblies attached thereto. The invention provides an enclosure adapted for placement within a keyhole and about a pipe portion and valve assembly. Advantageously, the present invention is particularly suitable for protection of pipe portion and valve assemblies typically located underground.

In one aspect, the present invention provides a system for the protection of pipe portion and fixtures attached thereto. The system comprises a first member including an enclosure forming a cavity. The first member is defined by one or more wall portions extending between a first end and a second end of the first member, the one or more wall portions defining at least a portion of a first opening and a second opening both of which extend into the cavity. The system further comprises a base portion adapted to engage the first or second end of the first member and optionally define at least a portion of the first, second or both openings.

In another aspect, the present invention provides a method of protecting an underground pipe portion and fixture attached thereto. The method comprising the steps of: providing a first pipe portion having a fixture attached thereto and second pipe portion extending from the fixture; placing a base portion below the first and second pipe portion and fixture; enclosing the first pipe portion, second pipe portion and fixture with an enclosure. The enclosure comprises one or more wall portions extending between a first end and a second end of the first member, the one or more wall portions defining at least a portion of a first opening and a second opening both of which extend into the cavity; wherein the first pipe portion extends through the first opening, the second pipe portion extends through the second opening and the fixture resides substantially within the cavity. Finally, the method includes attaching the enclosure to the base portion.

### DESCRIPTION OF THE DRAWINGS

FIG. 1 is a perspective view of an enclosure system of the present invention.

FIGS. 2a-d are progressive views of an enclosure system of the present invention during installation onto a pipe portion.

FIGS. 3a-d are progressive views of an enclosure system of the present invention during installation onto a pipe portion.

FIGS. 4a-c are progressive views of an enclosure system of the present invention during installation onto a pipe portion.

FIG. 5 is a perspective view of an enclosure system of the present invention.

FIGS. 6a-e are additional views of an enclosure system of the present invention and a first tool adapted for use therewith.

FIGS. 7a and d illustrate views of a second tool adapted for use in the installation of the present invention.

FIG. 8 illustrates a third tool adapted for use in the installation of the present invention.

FIGS. 9a and b illustrate a protective sleeve in accordance with the teachings of the present invention.

FIG. 10 illustrates another enclosure system in accordance with the teachings of the present invention.

### DETAILED DESCRIPTION OF THE INVENTION

The present invention provides a system and method for protecting conduits such as pipe portions from damage. More particularly, the present invention provide systems and methods for protecting one or more pipe portions and fixtures extending therefrom from damages resulting from utility repairs, material corrosion, earth shifting or otherwise. Preferably this protection is in the form of a compact enclosure having a base portion and cover portion adapted to enclose the one or more pipe portions and features attached thereto. It should be appreciated that the cover portion and/or base portion may be integrally formed with the enclosure or alternatively comprise separate components. Advantageously, the systems of the present invention allows pipe portion to extend into and/or out of the system and provide protection to the pipe portions contained therein and fixtures attached thereto.

Preferably, the enclosure of the present invention provides a barrier between the surrounding environment (e.g., dirt, rocks or otherwise) and change one or more pipe portions and fixtures contained therein. More preferably, the enclosure provides a cavity between the enclosed one or more pipe portions and fixture and the surrounding environment. As such, the present invention may further include an additional corrosion protective material filling at least a portion of the cavity within the system to protect enclosed pipe portions and fixtures from the surrounding environment (e.g., water, moisture, corrosive solids or liquids materials, moving earth or otherwise).

In one application, the protective layer comprises a material wrapped about at least a portion of the one or more pipe portions and/or fixture. In another application, the protective layer comprises a material inserted into the cavity, which covers at least a portion of the one or more pipe portions and/or fixture.

In application, the present invention may be used with conduit systems having fixtures or branches extending therefrom. However, advantageous application is in the in the field of utilities (e.g., gas, water, telephone, electricity, cable television or otherwise). Another advantageous application is in the natural gas industry, which may include a network of underground pipes.

In any of the above applications, the present invention is particularly useful when used in conjunction with keyhole technology, as previously discussed. Keyhole technology, is the accessing of underground pipe portion for modification repair or otherwise, wherein a substantially vertical hole is formed to access the desired pipe portion while minimizing the amount of disturbance to the surrounding area. For example, a circular hole may be created having a diameter less than about one half meter with substantially vertical walls. Similarly, are square or rectangular hole having substantially vertical walls may also be created. It should be appreciated that preferably the hole is minimally sized, typically making it difficult for a person to enter the keyhole and work on the pipe portions without the use of tools. As such, the enclosure of the present invention is adapted to be placed into the above-mentioned holes and lowered so as to enclose one or more pipe portions and fixtures (e.g. valve assembly).

The lowering and placing of the enclosure about the pipe and valve assembly may be accomplished with the use of keyhole tools as disclosed herein. Keyhole tools, which may be used in the present invention includes a gripping member or the like, and is capable of raising, lowering, and manipulating components of the enclosure about the pipe portions and fixture.

Optionally, after enclosing a pipe portion and valve assembly with the enclosure of the present invention, any resulting cavity located between the pipe portion, valve assembly and the enclosure is filled with a protective material to protect the same from damage (e.g., corrosion or otherwise). Alternatively, a protective wrap or material may be placed on the pipe portion and/or fixture. Still further, the enclosure may be filled with a protective material prior to placement onto a pipe portion and/or fixture.

While the remaining description recites pipe portions and fixtures attached thereto, it should be appreciated that the enclosure of the present invention may be used with other types of conduits and features. For example, fixtures may include valves, joints, fittings, connectors, metering devices, combinations thereof or otherwise. In one particular embodiment, the enclosure of the present invention may be configured to enclose a first pipe portion attached to a second pipe portion through a valve.

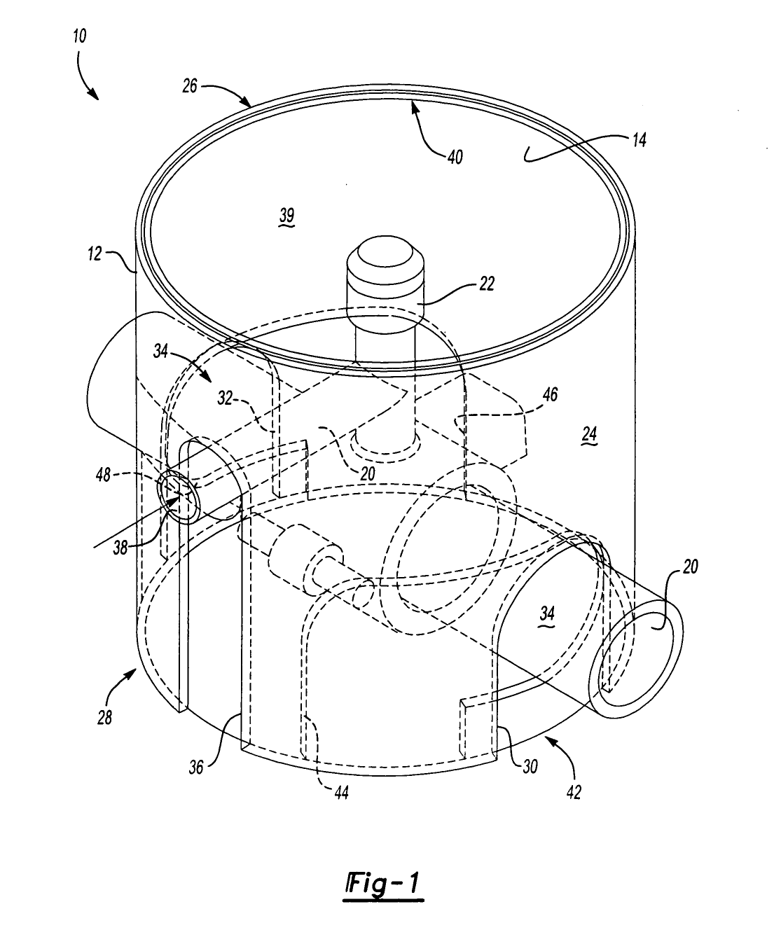

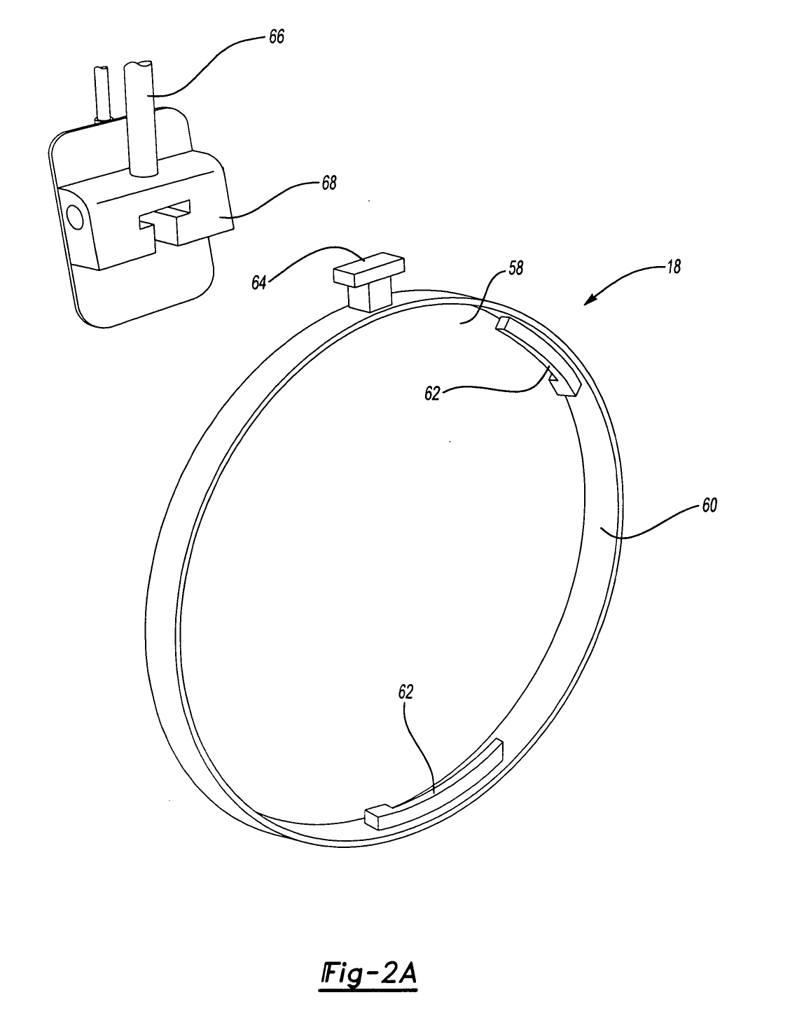

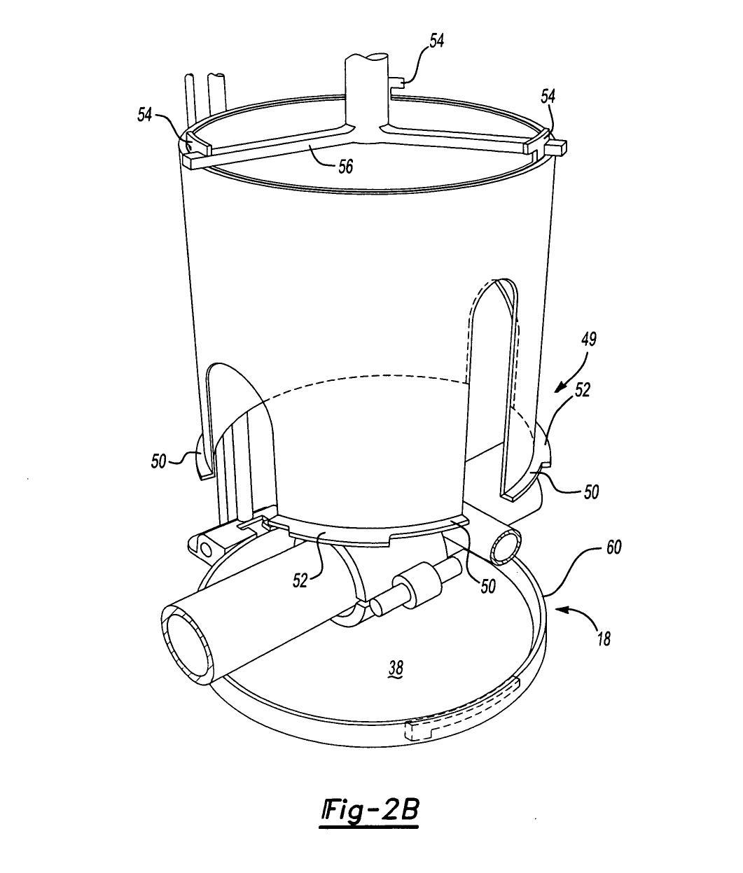

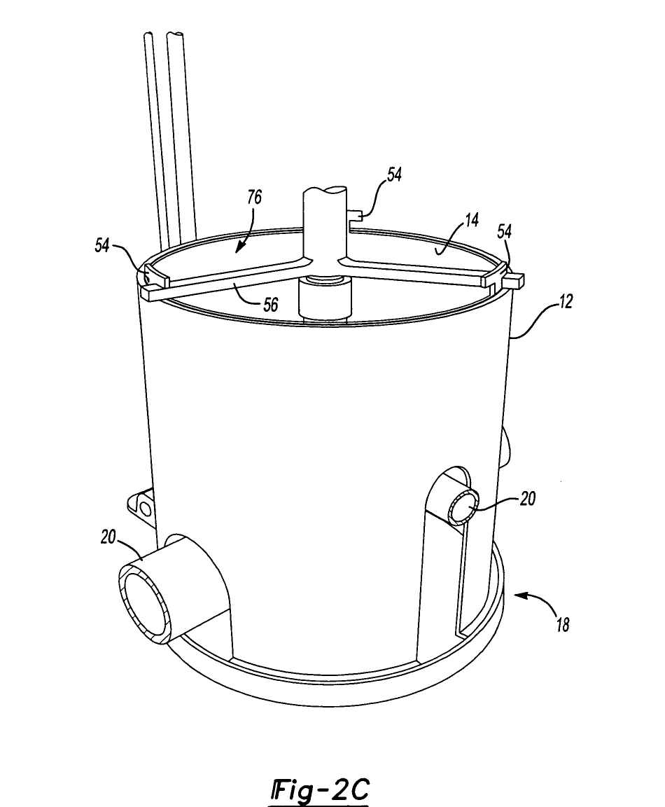

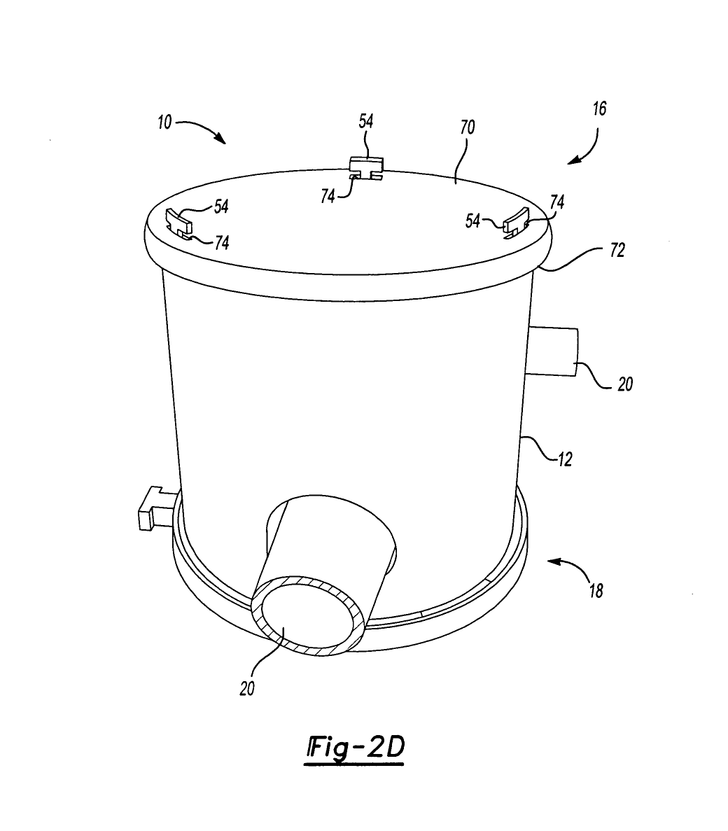

Referring to FIGS. 1 and 2a-d, two configurations of a fist embodiment of the present invention is shown. The systems 10 provides a first cylinder 12, a second cylinder 14, a cover portion 16 and a base portion 18. The first and second cylinder portions 12, 14 are adapted to receive a pipe portion 20 and fixture 22 (e.g., a valve assembly or otherwise). However, preferably first cylinder 12 is adapted to receive the second cylinder 14 and is in a sliding engagement therewith.

Preferably, the first cylinder 12 is configured with vertical cylindrical walls 24 having constant thickness and cross-section, wherein the cylindrical walls 24 comprise a first end 26 and a second end 28. Extending from the second end 28 are two channels 30, 32 adapted to form a portion of a first opening 34. Also, at least one other channel 36 extends lengthwise from the second end 28 to form a portion of a second opening 38. The width of the channels 30, 32, 36 are suitable so as to receive pipe portion 20. More preferably, the width of the channels 30, 32, 36 are approximately the same as a pipe portion 20 residing therein.

Advantageously, the first opening 34 travels the entire width of the first cylinder 12 and/or system so as to receive pipe portion 20. However, it is also contemplated that the system 10 may only receive a pipe portion (such as at the end of a pipe line or otherwise. As such, the opening may only exist on one side of the system 10. By example, the second opening 28 is arranged in this manner wherein the second opening 38 only exist on one side of the system 10.

Turning now to the second cylinder, preferably the second cylinder 14 is also configured with vertical cylindrical walls 39 having generally a consistent thickness and cross-section. The cylindrical walls 39 comprise a first end 40 and a second end 42. The extending lengthwise from the second end 42 are two channels 44, 46 adapted to form a portion of the first opening 34. Also, at least one other channel 48 extends lengthwise from the second end 42 to form a portion of the second opening 38. However, channels 44, 46, 48 also extends radially with respect to the cylinder to form a generally ‘L-shaped’ channel, albeit upside down and inverted, depending upon orientation.

It should be appreciated channels 30, 32, 36, 44, 46 and 48 and first and second opening 34, 38 may have different widths or diameters to accommodate different size paper portions 18 entering and exiting the system 10.

Preferably, the second cylinder 14 further comprises an attachment feature 49 such as a flared radial portion 50 extending approximately perpendicular from the second end 42 with respect to the length of the second cylinder 14, for securing the second cylinder to the base portion 18. It should be appreciated that the flared radial portion 50 may extend beyond the first cylinder 12, to provide support structure for the first cylinder 12 and for attachment to the base portion. For example, referring to FIG. 2b, the flared radial portion 50 extends about the entire second end portion 42 to support the first cylinder and includes one or more projecting fingers 52 extending radially therefrom with respect to the second cylinder 14 to engage the base portion.

Preferably, the second cylinder 14 further comprises one or more engaging features 54 for manipulation of the second cylinder 14, and the first cylinder 12 as a result of the flared radial portion 50. As best illustrated in FIGS. 2b-c, one preferred engaging feature 54 comprises three radially positioned engaging features 54 adapted to matingly engage with a corresponding structure. Preferably, the engaging features 54 extend lengthwise from the first end 26 and are adapted to engage a rotating structure and transmit the resulting force therefrom. By example, the engaging feature 54 may comprise a ‘T-shaped’ member adapted to engage a rotating arm 56.

The present embodiment also provides a base portion 18 preferably adapted to receive the first and second cylinders 12, 14 at second ends 28, 42 and engage with the first or second cylinders 12, 14. By example, as best illustrated in FIGS. 2a-d, base portion 18 may comprise generally of a disk portion 58 having a radial sidewall 60 extending therefrom to form a cup-like member. The disk portion 58 preferably contacts the flared radial portion 50 of the second cylinder 14 when the same are joined.

Preferably, the base portion 18 further comprises and attachment feature for mounting with the first or second cylinder 12, 14. For example, as illustrated in the drawings, the base portion 18 may further comprise one or more slotted or grooved portions 62 located in the inner portion of the sidewall 60. The grooved portions 28 are adapted to slidably engage with the one or more projecting fingers 52 extending from the flared radial portion 50 and maintains a spatial relationship between the base portion 18 and second cylindrical portion 14.

Advantageously, the base portion 18 may further comprise an engagement feature 64 adapted to matingly engage an installation tool portion for manipulation therefrom. For example, as best shown in FIGS. 2A-B, a control arm 66 may be used to lower the base portion 18 into a keyhole or otherwise and then rotate the base portion 18 into a desired position under a pipe portion and fixture. It should be appreciated that the control arm 66 comprises a corresponding engagement feature 68 to that of the engagement feature 64 of the base portion 18.

The present embodiment also contemplates a cover portion 16 preferably adapted to receive the first and second cylinders 12, 14 at first end 26, 40 and engage with the first or second cylinders 12, 14. By example, as best illustrated in FIG. 2D, cover portion 16 may comprise generally of a disk portion 70 having a radial sidewall 72 extending therefrom to form a cup-like member. The disk portion 70 preferably contacts the first and/or second cylinders 12, 14 when joined with the cover portion 16.

Preferably, the cover portion 16 includes an attachment feature for mounting with the first or second cylinder 12, 14. For example, as illustrated in the drawings, the cover portion 16 may further comprise one or more openings 74 adapted to receive the engaging feature 54 of the second cylinder 14 and maintains a special relationship between the second cylinder 14 and cover portion 16. It should be appreciated that alternatively the base portion or particularly the cover portion may be integrally formed with the first and or second cylinder.

In a preferred configuration, the system 10 may further include a material, as discussed herein, 76 adapted to coat and protect a pipe portion 20 and fixture 22 from corrosion as discussed herein. The material may include a pumpable or wrapable material adapted to adhere to pipe portions and valve assemblies located within the enclosed system. Preferably, the material includes corrosion resisting properties.

The present invention also contemplates a method of protecting underground pipes 20 and valve assemblies 22 using the system 10 of the first embodiment. In general, the method includes placing the base portion 18 under a pipe portion 20, placing the first and second cylinder 12, 14 around the pipe portion 20 and fixture 22, mounting the first or second or both cylinders 12, 14 to the base portion 18, forming the first and second openings for the pipe portion and mounting a cover portion 16 to the first or second or both cylinders 12, 14. Preferably, a material 76 may be placed over the pipe portion 20 and fixture 22 prior to placement of the cover portion 16 to provide protection from corrosion or otherwise.

In greater detail, the method includes attaching the base portion 18 to control arm 66, which is adapted to be used with keyholes formed in the ground. The attachment feature 64 of the base portion is inserted in a corresponding engagement feature 68, wherein the resulting engagement allows the base portion to be manipulated into different potions using friction resistance cause by the weight of the base portion. It should be appreciated that other engagement arrangements are available.

The base portion 18 is then lowered into the keyhole opening and below an exposed pipe portion and advantageously a fixture. The base portion 18 is rotated into a substantially horizontal position to engage the first or second cylinder, wherein the opening of the base portion 18, formed by the disk portion 58 and sidewalls 60, is facing the exposed pipe portion 20 and fixture 22.

With the base portion 18 in place, the first and second cylinder 12, 14 are attached to a tool having rotating arms 56 adapted to lower the first and second cylinder 12, 14 into the keyhole opening. A preferred tool is further configured to rotate the second cylinder 14 with respect to the base portion 18 and first cylinder.

Prior to placement around the pipe portion and valve assembly, channels 30, 32, 36 of the first cylinder 12 are aligned with channels 44, 46, 48 from the second cylinder, respectively. The aligned channels 30 and 44, 32 and 46, and 36 and 48 are then aligned with pipe portions 20. Preferably, the width of the channels are generally the same as the diameter of the corresponding pipe portions 20.

The rotating arms 56 and first and second cylinder 12, 14 are then lowered so that the pipe portions 20 are within the channels 30 and 44, 32 and 46, and 36 and 48 and the flared radial portion 50 is within the radial sidewalls 60 and substantially flush with the disk portion 58 of the base portion 18.

The second cylinder is then rotated, via rotating arms 56, with respect to the first cylinder and the base portion 18. This causes the pipe portions 20 to reside in the radial portion of channels 44, 46, 48 of the second cylinder 14. The resulting opening formed by the channels of the first and second cylinder channels forms the first and second opening 34, 38. Also, as a result of the rotation of the second cylinder, the projecting finger portions 52 extending from the flared radial portion 50 enters the groove portion 62 of the base portion. Because there are three equally spaced finger portions 52 and groove portions 62, the spatial relationship between the base portion 18 and the second cylinder portion 14 is maintained during residency of the spaced fingers 52 within the groove portion 62.

It should be appreciated that the rotation of the second cylinder with the first cylinder reduces the size of the first and second openings. This reduction in size is advantageous as it limits the amount of material placed in the system from leaking. Furthermore, this configuration locks the first cylinder, second cylinder and base portion the pipe member.

As best shown in FIGS. 2i and j, optionally, the pipe portion 20 and attached fixture 22 may be coated with a layer of protective material 76. In one application, the protective material 76 comprises a protective layer is applied to the pipe portion and valve assembly prior to enclosure of the same. In another application, the protective material 76 comprises a protective layer that is pumped or otherwise placed within the system 10 either after the base portion 18 and second cylinder 14 have been joined or before. The material may be placed using any of the techniques disclosed herein including a mastic pump.

After the application of the protective material 76, if desired, the cover portion is aligned over the first and second cylinders 12, 14 so that the outer dimension of the first cylinder 12 is aligned within the inner portion of the radial sidewalls 72. Likewise, the engaging features 54 of the second cylinder 14 are aligned with the openings 74 of the disk portion 70. When the cover is properly aligned over the cylinder portions, the cover is then lowered onto the same such that the engaging features 54 extend through the openings 74. Optionally, the engaging features 54 may be bent or otherwise positioned to substantially prevent spatial motion between the cover portion 16 and second cylinder 14.

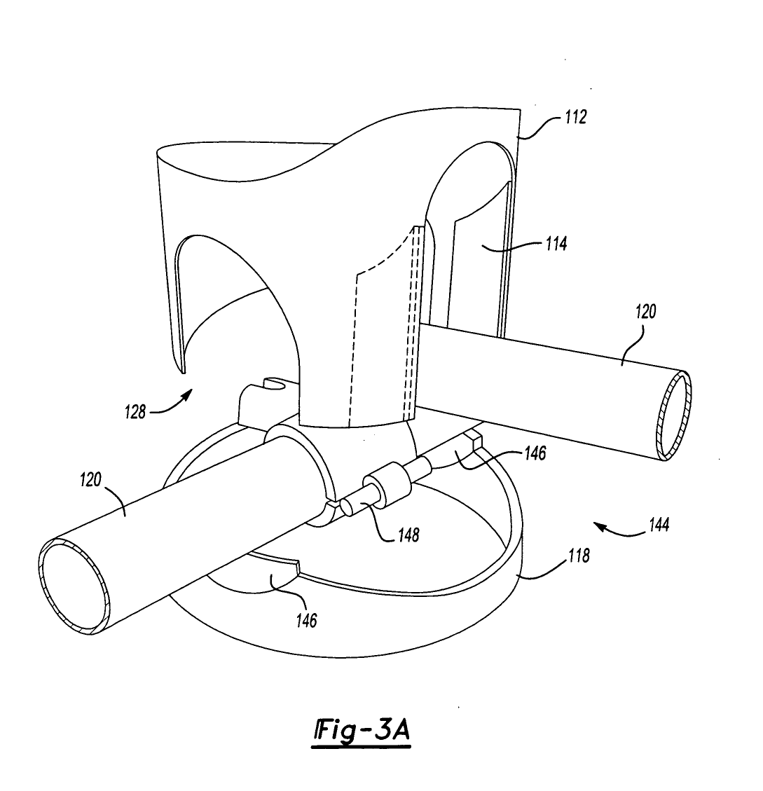

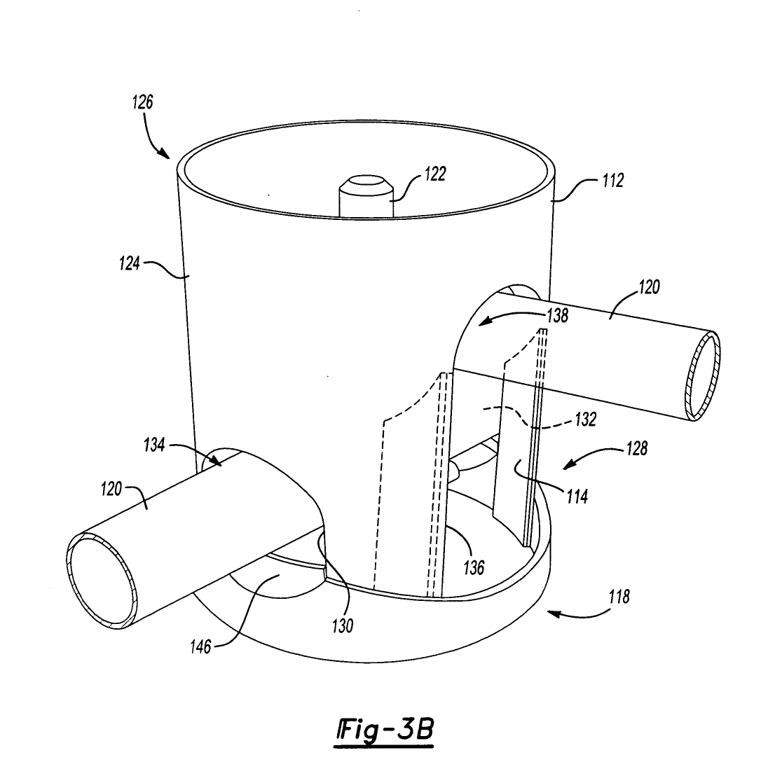

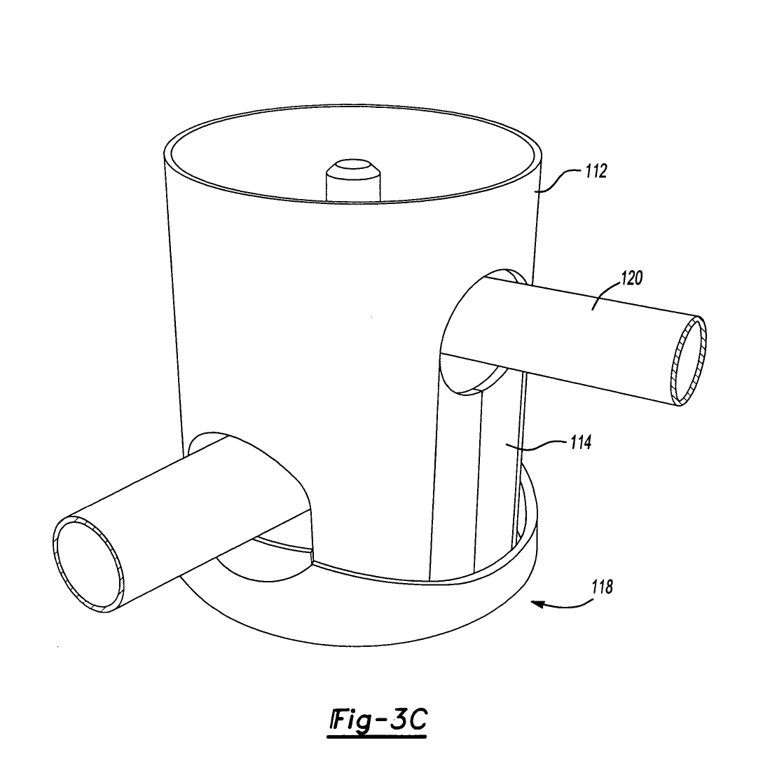

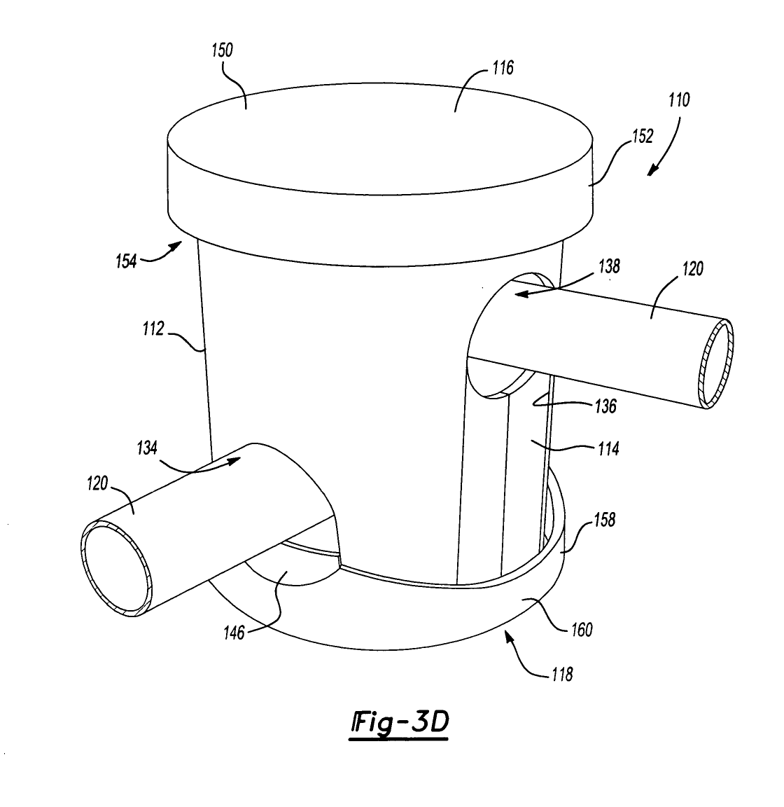

Referring to FIGS. 3a-d, an example of the second embodiment of the present invention is shown. Generally, the system 110 provides a cylinder 112 optionally having one or more gates 114, a cover portion 116 and a base portion 118. In this embodiment, the cylinder 112 is adapted to receive a pipe portion 120 and fixture 122 (e.g., valve assembly or otherwise) and enclose the same with the attachment of the base portion 118 and the cover portion 116.

The cylinder 112 includes a first end 126 and a second end 128 and preferably is configured with vertical cylindrical walls 124 having a consistent thickness and cross-section. Extending lengthwise from the second end 128 are two channels 130, 132 adapted to form a portion of a first opening 134. Also, at least one other channel 136 extends lengthwise from the second end 128 to form a portion of a second opening 138. Preferably, the width of the channels 130, 132, 136 are suitable so as to receive a pipe portion 120. It should be appreciated channels 130, 132 and 136 and first and second opening 134, 138 may have different widths or diameters to accommodate different size pipe portions 120 entering and exiting the system 110.

The cylinder 112 is optionally configured with one or more gate portions 114 adapted to move and out of channel 136 (and optionally channels 30 and 132) and form a portion of the second opening 138 (and optionally the first opening). Preferably, the end portions (i.e., the end opposite of the second end 128) of the one or more gate portions 114 are arcuate so as to correspond to the shape of the pipe portion 20 entering or exiting the system. It is also preferred that the gate portions 114 are adapted to limit ingress or egress of material through channel 136.

Advantageously, the one or more gate portions 114 are hingedly attached to the cylinder 112 so as to rotate into and out of the channel 136. It should be appreciated that the gate portions may be hinged so that the gate may swing externally, internally or both with respect to the system 110. However, a preferred gate swings internally to the cylinder 112 and stops when it becomes flush with the outer surface of the cylinder 112.

In the present embodiment, two gate portions 114 are attached to opposite sides of channel 136 and hingedly attached thereto. Preferably, the hinge is a living hinge formed with the cylinder. The gates 114 are adapted to swing internally with respect to the cylinder 112 to a position flush with the surface of the cylinder 112.

It should also be appreciated that a separate hinge assembly may be utilized to pivotally mount the gate portions 114 to the cylinder 112. Suitable hinges that may be used with the present embodiment include: living hinge, frictionless hinge, pin or pinless hinge, butt hinge, barrel hinge, concealed hinge, blum hinge, gate hinge, continuous hinge, piano hinge, spring hinge, hager hinge, weld on hinge, strap hinge, pivot hinge, amerock hinge, flat hinge, slip hinge or otherwise.

The present embodiment also provides a base portion 118 preferably adapted to receive cylinder 112 and matingly engage with cylinder 112. By example, as best illustrated in FIGS. 3a-d, base portion 118 comprises generally of a disk portion 140 having a radial sidewall 142 extending therefrom to form a cup-like member having an open end 144 adapted to receive cylinder 112. The disk portion 140 and interior portion of the radial sidewall 142 preferably contacts the cylinder 112 when joined with the base portion 118, and optionally forms a friction fit.

It should be appreciated that the radial sidewall 142 may be variable in height or comprise one or more recessed portions. In the present embodiment shown, the radial sidewall 142 comprises two arcuate portions 146, 148, which form a portion of the first opening 134. Advantageously, the two arcuate portions may be elastically deformable and form around a pipe portion located in the first opening when the cylinder 112 and the base portion 118 are joined. It should be appreciated that the two arcuate portions 146, 148 may comprise a different material then that of the base portion 118. It should be appreciated that this configuration assists in reducing the amount of material exiting the system.

As with the other embodiments contained herein, the second embodiment may contain an attachment feature (e.g., the groove and finger engagement described in the first embodiment) for attaching the cylinder 112 with the base portion 118. Likewise, the base portion 118 may further comprise an engagement feature (e.g., the engagement feature of the cover portion and tool as described in the first embodiment, or otherwise) adapted to matingly engage a tool portion for manipulation therefrom.

The second embodiment further contemplates a cover portion 116 adapted to receive cylinder 112. Preferably, the cover portion 116 is adapted to matingly engage with cylinders 112. By example, as best illustrated in FIG. 3d the cover portion 116 may comprise generally of a disk portion 150 having a radial sidewall 152 extending therefrom to form a cup-like member having an open end 154 adapted to receive cylinder 112. The disk portion 150 and interior portion of the radial sidewall 152 preferably contacts the cylinder 112 when joined with the cover portion 116 to form a friction fit.

As with the other embodiments contained herein, the second embodiment may contain an attachment feature (e.g., the second cylinder engaging features and cover openings) for mounting the cylinder 112 with the cover portion 116. Likewise, the cover portion 116 may further comprise an engagement feature (e.g., the engagement feature of the cover portion and tool as described in the first embodiment) adapted to matingly engage a tool portion for manipulation therefrom.

It should be appreciated that alternatively the base portion or particularly the cover portion may be integrally formed with the first and or second cylinder.

Preferably, the second embodiment may further include a material 156 as discussed herein, adapted to coat and protect a pipe portion 120 and fixture 122 from corrosion as discussed herein. The material may include a pumpable material, wrapable material or otherwise adapted to adhere to pipe portions 120 and fixture 122 located within the enclosed system 110. Preferably, the material 156 includes corrosion resisting properties.

The present invention also contemplates a method of protecting underground pipes 120 and fixture 122 using the system 110 of the second embodiment. The method generally includes placing the base portion 118 under a pipe portion, placing the cylinder 112 around the pipe portion 120 and fixture 122, mounting the cylinder 112 to the base portion 118 and mounting the cover portion 116 to the cylinder 112. Preferably, a material 156 may be placed over the pipe portion 120 and fixture 122 prior to placement of the cover portion 116 to provide protection from corrosion or otherwise.

In greater detail, referring to FIGS. 3a-d the method includes lowering the base portion 18 into the keyhole opening formed in the ground and below an exposed natural gas pipe portion 120 and a fixture 122. The base portion 118 is then rotated into a substantially horizontal position wherein the opening of the base portion 118, formed by the disk portion 158 and sidewalls 160, is facing the exposed natural gas pipe portion 120 and fixture 122.

The cylinder 112 is then placed over the base portion 118 such that the channels 130, 132, 136 extending from the second end 128 are aligned over the pipe portions 120. The second end 128 of the cylinder 112 is then lower into the open end 144 of the base portion 118 such that the cylinder 112 is within the sidewalls 142 and generally flush with the disk portion 140. This attachment of the base portion 118 with the cylinder 112 results in the pipe portions 120 residing within the first and second openings 146, 148 formed at least in part by channels 130, 132, 136 and the two arcuate portions 146, 148 of the base portion 118.

Upon seating of the cylinder 112 within the base portion 118, gates 114 are rotated into to channel 136 to further define opening 138. Preferably the flow of material through channel 136 is limited due to gates 114. Preferably, the outer portions 158 of the gates 114 are flush with the outer surface 160 of the cylinder 112.

Optionally, the cylinder 112 is filled with material 156 for providing corrosion protection for the pipe portion 120 and fixture 122. The material may be placed using any of the techniques disclosed herein including a mastic pump. Advantageously, the configuration of the channels 130, 132, 136, gates 114 and base portion 118 are such that the material 156 is prevented or at least limited from flowing from within the system 110 to an exterior region to the system 110.

The cover portion 116 is then aligned and placed onto the cylinder 112 such that the first end of the cylinder portion is generally flush with disk portion and is substantially surrounded by the radial sidewall.

It should be appreciated that as with the first embodiment, the method associated with the second embodiment may comprise similar tools for manipulation of the system 110 components (e.g., cylinder 112, cover 116, base 118) within a keyhole. As such, it should be appreciated that these components may further comprise attachment features for engagement to the tools.

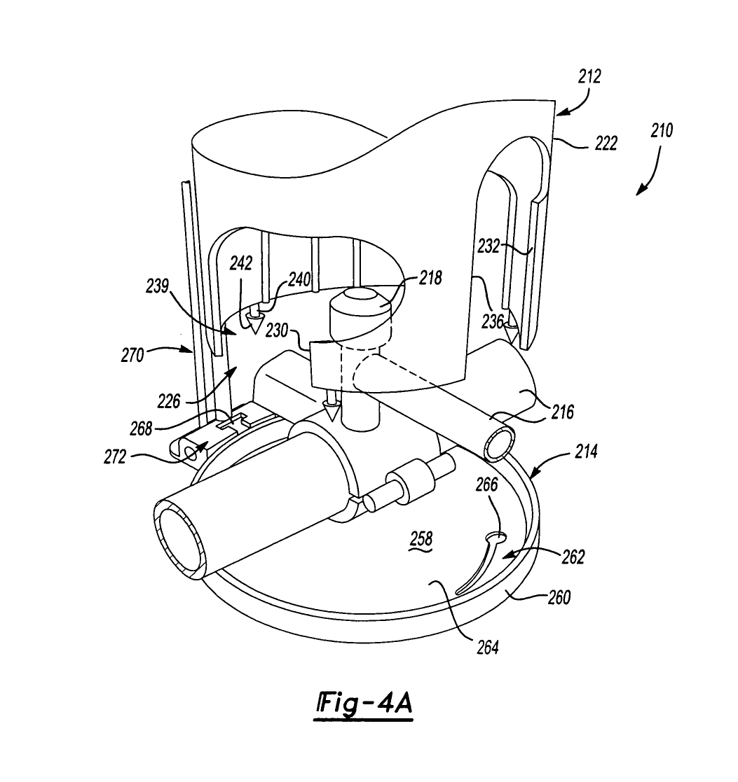

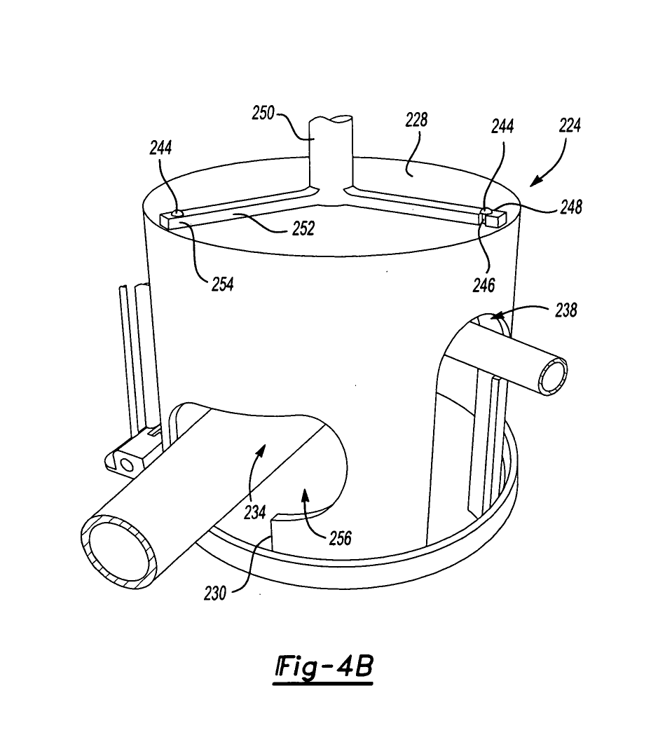

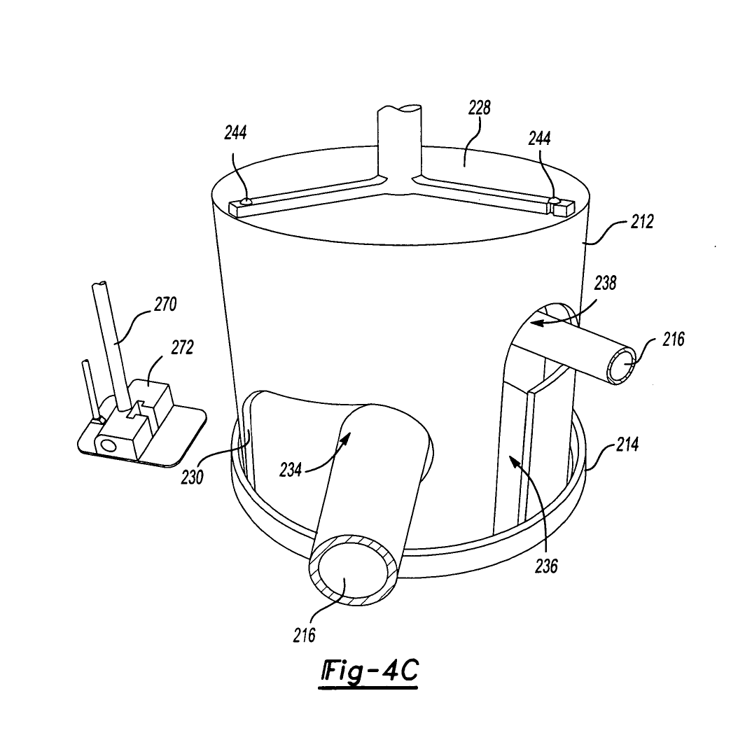

Referring to FIGS. 4a-c, an example of the third embodiment of the present invention is shown adapted to be used with keyhole technology for enclosing a pipe portion and fixture (e.g., a valve assembly or otherwise) extending therefrom. Generally, the system 210 provides a partially closed cylinder 212 and a base portion 214, the cylinder 212 being adapted to receive a pipe portion 216 and fixture 218 and contain a material 220 therein. Preferably, the cylinder 212 is at least partially hollow and is configured with vertical cylindrical wall 222 having consistant thickness and cross-section. The cylinder 212 further includes a first closed end 224 and a second open end 226. A preferred closed end comprises a disk portion 228 joined to the cylindrical walls 222.

The second end 228 of the cylinder 212 comprise two channels 230, 232 extending lengthwise therefrom and are adapted to form a portion of a first opening 234 for receiving a pipe portion 216. However, channels 230, 232 also extends radially with respect to the cylinder 212 to form a generally ‘L’-shaped channel 236, albeit upside down and inverted depending upon orientation. Also, at least one other channel 236 extends lengthwise from the second end 226 to form a portion of a second opening 238, also for receiving a pipe portion 216. Preferably, the width of the channels 230, 232, 236 are approximately the same as a pipe portion 216 residing therein. It should be appreciated channels 230, 232, 236 and first and second opening 234, 238 may have different widths or diameters to accommodate different size pipe portions 216 entering and exiting the system 210.

Advantageously, the first opening 234 is adapted to receive the pipe portion 216 and thus extends the width of the cylinder 212. However, it is contemplated that the system 210 may only receive a pipe portion 216 (such as at the end of a pipe portion or otherwise) and not provide an exit portion on an opposite portion of cylindrical wall 222. As such, the opening may only exist on only one side of the system 210. By example, the second opening 28 is arranged in this manner wherein the opening only exist on one side of the system 210, which provides an exit for a pipe portion 216 extending from the fixture 218.

Preferably the cylinder 212 further comprises one or more mounting features 239 adapted to engage a member (e.g., base portion 214) having a slotted opening for mounting the cylinder 212 to the same. A preferred mounting feature 239 comprises a shaft portion 240, be it rounded or otherwise, having an end portion 242 larger in diameter then the shaft portion 240. The end portion 242 comprises a cone mounted to the shaft portion 240 at a base portion of the cone.

As best seen in FIGS. 4b-c, preferably the first end 224 of the cylinder 212 includes one or more engaging features 244 extending perpendicularly from the disk portion 226, which are adapted to engage with a tool for manipulation therefrom. A preferred engaging feature comprises three radially positioned engaging features 244 which are adapted to matingly engage with a corresponding structure or engaging feature. A preferred engaging feature 244 comprises a shaft portion 246, be it rounded or otherwise, having an end portion 248 larger in diameter then the shaft portion 246. As such, it is contemplated that the engaging features 244 engages a tool member 250 having extending arms 252 with corresponding engaging features 254, wherein the tool member is adapted to manipulated the location of the cylinder 212 and provide a rotational force to rotate the cylinder with respect to the base portion 214.

Advantageously, the present embodiment optionally includes a material 256 adapted to coat and protect a pipe portion 216 and fixture 218 as discussed herein. Suitable materials includes a pumpable or wrapably material adapted to adhere to pipe portions and valve assemblies located within the enclosed system and provides corrosion protection. However, a one preferential material also adheres to the interior portion of the cylinder 212 during assembly of the system and surrounds and adheres to the pipe portion 216 and valve assembly 218 as the pipe portions 216 are placed within the first and second openings 234, 238.

The present embodiment also provides a base portion 214 preferably adapted to receive cylinder 212 and to matingly engage with the cylinders 212. By example, as best illustrated in FIG. 4a, base portion 214 comprises generally of a disk portion 258 having a radial sidewall 260 extending therefrom to form a cup-like member having an open end adapted to receive cylinder 212. The disk portion 258 preferably contacts the cylinder wall 222 when joined with the cylinder 212.

Preferably, the base portion 214 comprises and mounting features 262 adapted to engage with mounting features 238 of the cylinder 212. A preferred mounting feature 262 includes a slotted portion 264 radially extending about the center of the base portion 214, wherein the width of the slotted portion is approximately equal to the diameter of the shaft 246 of mounting feature 238 so that the cylinder 212 can rotate within the sidewalls 260 of the base portion 214. The mounting feature 262 further includes an opening 266 located along the slotted portion 264, which has a diameter approximately equal or slightly larger than the end portion 248 of mounting feature 238. As such, the end portion 248 may be inserted through the opening 266 such that the shaft 246 may slide within slotted portion 264 and the base portion 214 and cylinder 212 do not separate when the shaft 246 is in slotted portion due to the diameter of the end portion 248 being larger than the slotted portion 264.

Advantageously, the base portion 214 may further comprise an engagement feature 268 adapted to matingly engage a tool portion for manipulation therefrom. For example, as best shown in FIG. 4c, a control arm 270 may be used to lower the base portion 214 into a keyhole or otherwise and then rotate the base portion 214 into a desired position under a pipe portion 216 and valve assembly 218. It should be appreciated that the control arm 270 comprises a corresponding engagement feature 272 to that of the engagement feature 268 of the base portion 214 to provide control thereof.

The present invention also contemplates a method of protecting underground pipes and fixtures (e.g. valve assembly or otherwise) using the system 210 of the third embodiment. The method generally includes placing the base portion 214 under a pipe portion and placing the cylinder 212 over the pipe portion 216 and valve assembly 218, mounting the cylinder 212 to the base portion 214. Preferably, a material may be placed inside of the cylinder 212.

By example, and in greater detail, the method includes attaching the base portion 214 to control arm 270, which is adapted to be used with keyholes formed in the ground. The attachment feature 268 of the base portion 214 is inserted in a corresponding engagement feature 272 wherein the resulting engagement allows the base portion 214 to be manipulated into different potions using friction resistance cause by the weight of the base portion 214 or otherwise.

The base portion 214 is then lowered into the keyhole opening and below an exposed natural gas pipe portion 216 and a fixture 218 extending therefrom. The base portion 214 is then rotated into a substantially horizontal position wherein the opening of the base portion 214, formed by the disk portion 258 and sidewalls 260, is facing the exposed natural gas pipe portion 216 and fixture 218 attached thereto.

With the base portion 216 in place, the cylinder 212 is attached to a tool 250 adapted to lower the cylinder 212 into the keyhole opening. A preferred tool 250 comprises rotating arms 252 having engaging features 254 adapted to rotate the cylinder 212 with respect to the base portion 214.

The openings of channels 230, 232, 236 of the cylinder 212 are aligned with pipe portions 216. The tool 250 then lowers cylinder 212 so that the pipe portions 218 are within the channels 230, 232 and 236 and the end portions 242 of the mounting feature 239 is projecting through the opening 266 of mounting feature 262.

The cylinder 212 is then rotated, via rotating arms 252, with respect to the base portion 216. This causes the pipe portions 216 to reside in the radial portion of channels 230, 232 and 236 and causes shaft 240, of the mounting feature 239, to enter the slotted portion 262 thereby limiting spatial movement between the disk portion 258 of the base portion 216 and the second end of the cylinder 212. Preferably, the rotational movement locks the cylinder/enclosure and base to the pipe portion.

Preferably, the interior portion of the cylinder 212 is filled with material 256, as discussed herein, which is adapted to assist in corrosion prevention to the same. In the application shown, the protective material 256 comprises a material placed within the cylinder 212 so that when the cylinder is joined with the base portion 216 the material 256 envelops the pipe portion 216 and valve assembly 218. Other material applications are available as disclosed herein.

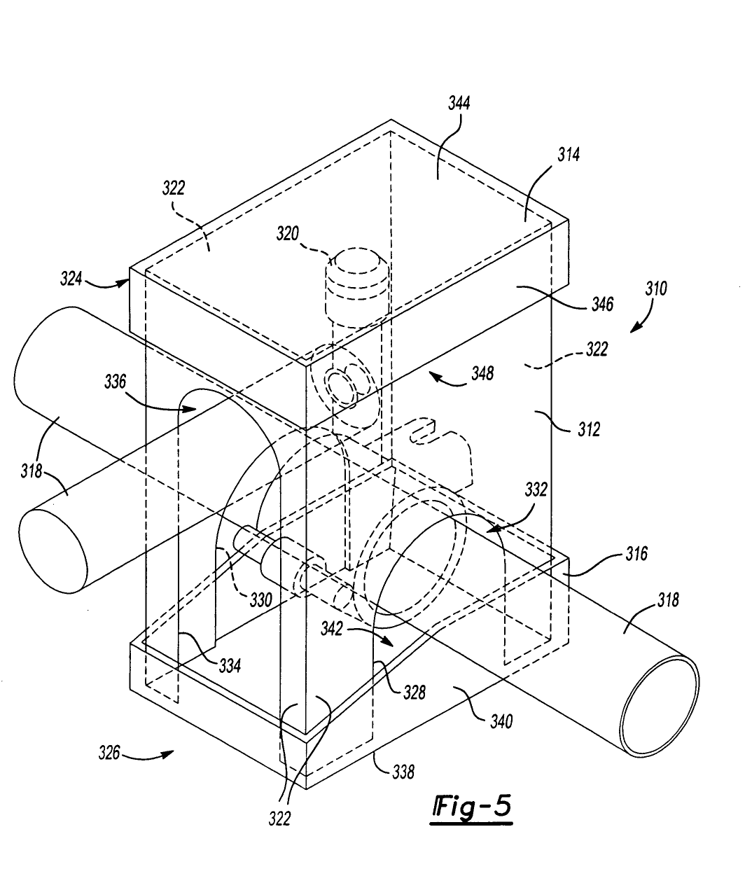

It should be appreciated that in any of the embodiments contained herein, the shape of the system may vary from a cylindrical shape. For example, FIG. 5 illustrates a fourth embodiment of the present invention, which is different in shape from the other embodiment disclosed thus far. By example, the system 310 includes an enclosure 312 having a cover 314 and a base portion 316, wherein the cover 314 and base 316 are adapted to be joined with the enclosure 312 to enclose a pipe portion and fixture (e.g. or otherwise).

Preferably, the joining of the cover and/or base to the enclosure includes an attachment feature for permanently or temporarily securing the components. The attachment feature may be associated with the cover, base, enclosure or a combination thereof. However, in a one preferred embodiment, particularly with respect to the base portion, the attachment feature is adapted to support the weight of any corrosion preventing material placed in the system. Suitable attachment features include: snap fits, hook and latch configuration, mechanical fasteners, adhesives, friction fit, or otherwise.

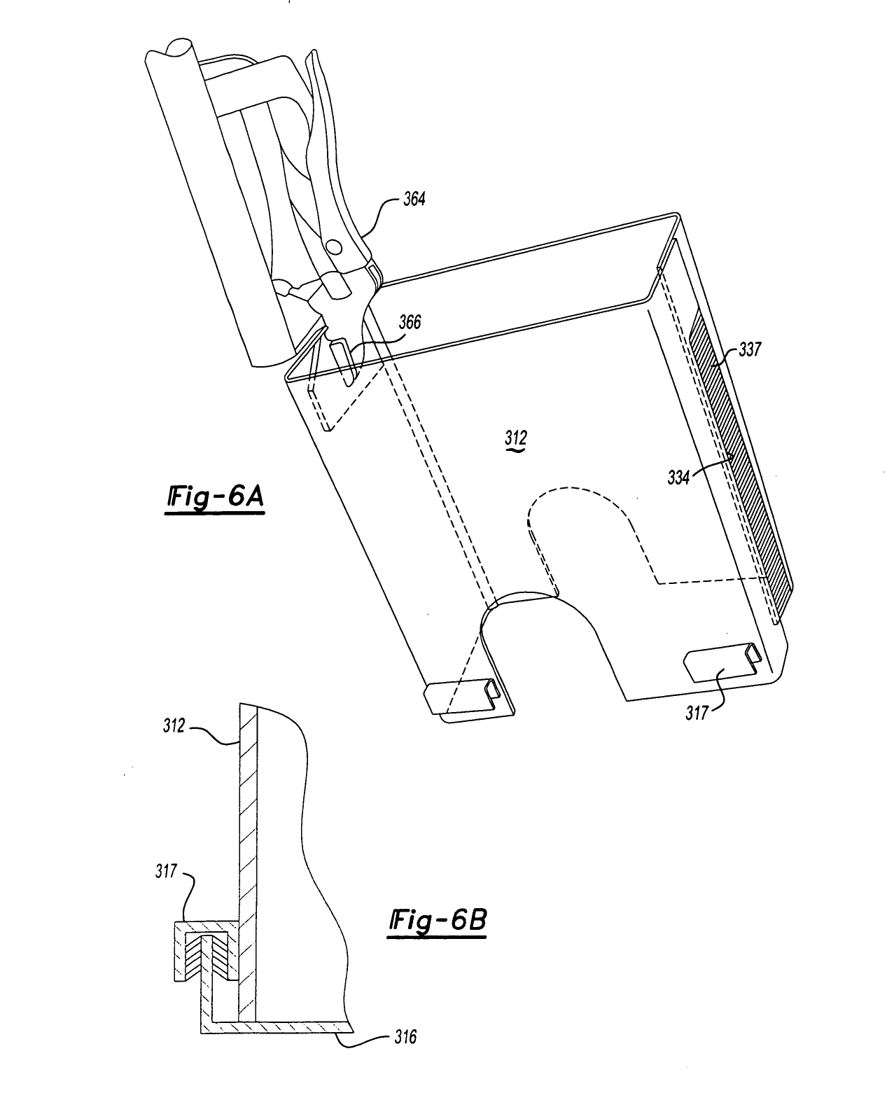

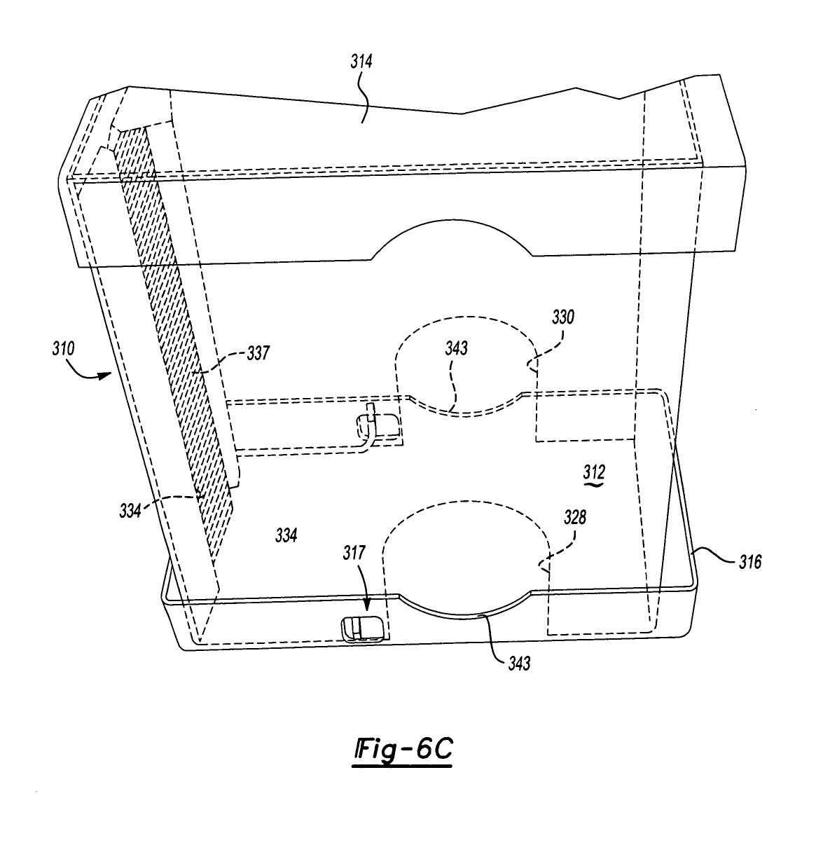

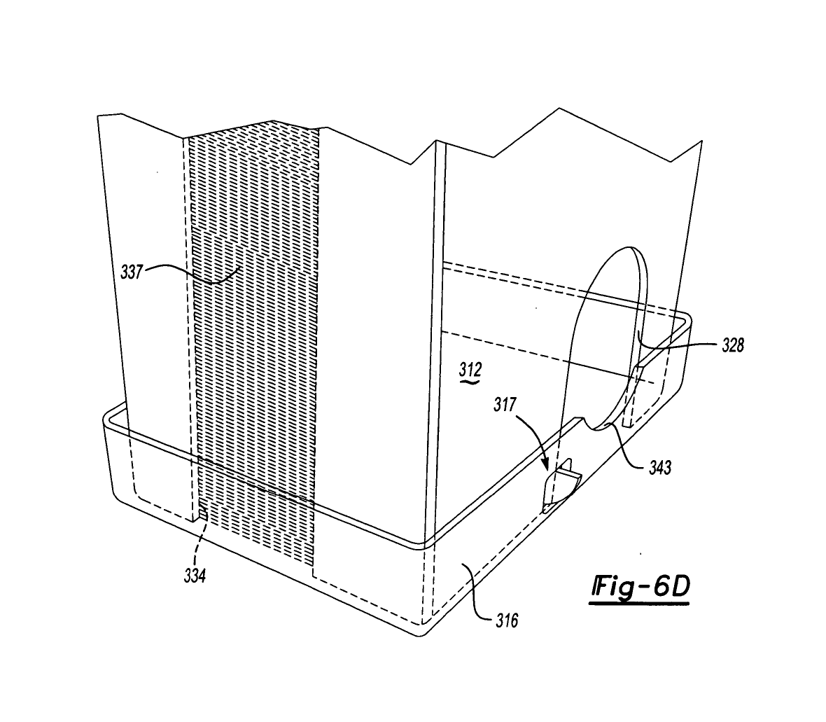

For example, referring to FIGS. 6a and 6b, one exemplary attachment feature 317 is shown. The attachment feature is adapted to form a friction fit between with an edge portion of the enclosure or base portion. As such, it should be appreciated that the attachment feature may be joined with the enclosure or base portion and be adapted to join to the other of the enclosure or base portion. Furthermore, it should be appreciated that the same configuration may exist between the enclosure and the cover portion.

Alternatively, the attachment feature may be separated into two or more components or features located on the enclosure and the cover and/or base portion. For example, referring to FIGS. 6c-6d, another attachment feature is shown. In this configuration, the attachment feature comprises a snap fit configuration, wherein the enclosure, base portion or both are adapted to elastically deform so that a projections extending from the enclosure can be received in an opening formed in the base portion. Again, it should be appreciated that the same configuration may exist between the enclosure and the cover portion. However other cross-sectional shapes are available. Referring to FIG. 6e, it is contemplated that the cover 314 may be attached to the enclosure 312 prior to placement of the enclosure within a keyhole or otherwise. In such a configuration, the cover may be integrated with the enclosure or the cover is attached to the cover through one or more fiction fasteners or otherwise. Accordingly, the fiction fasteners can be located on an internal portion of the cover configured for engagement with the walls of the enclosure. It should be appreciated that the friction fastener are configured for support of the enclosure and optionally any anticorrosion agent located therein. Furthermore, the walls of the cover may cover a portion of the enclosure walls. It should be appreciated that this attachment may be temporary or permanent.

Also, the cover 314 may further include a threaded fastening feature for attachment to a corresponding threaded faster (such as an enclosure tool similar to a broom stick or otherwise). In such a configuration, the cover may have attached (permanently through adhesives or otherwise, or temporarily) a male or female portion of a threaded fastener. A tool having a corresponding threaded portion may threadably engage the cover for lowering it onto an enclosure. Alternatively, as stated above, the threaded tool may lower both the cover and enclosure about a pipe portion and fixture attached thereto.

As previously mention, the enclosure 312 of the fourth embodiment comprises a box-like enclosure (e.g., cubical box, rectangular box or otherwise), which has a hollow interior and is adapted to receive the pipe portions 318 and fixture 320. As such, it should be appreciated that the enclosure 312 may include four or more walls 322, which are vertically aligned when placed over a pipe portion. Preferably, the four walls are joined at the ends approximately perpendicularly with one another to form a square or rectangular shaped cross-sectional profile.

Referring again to FIG. 5, the enclosure 312 includes a first end 324 and a second end 326. Extending lengthwise from the second end 326 are two channels 328, 330 adapted to form a portion of a first opening 332, which preferably extends through the enclosure. Also, at least one other channel 334 extends lengthwise from the second end 326 to form a portion of a second opening 336, which may or may not extend through the enclosure. Preferably, the width of the channels 328, 330, 332 are adequate so as to receive a pipe portion 318. More preferably, the width of the channels 328, 330, 332 are approximately the same as a pipe portion 318 residing therein. It should be appreciated that the pipe portion 318 extending through the channel 334 (e.g., the second opening) may be smaller than the pipe portion 318 extending through channels 328, 330 (e.g., the first opening), since the pipe portion of the first opening may comprise a supply line while the other pipe portion may comprise a branch thereof.

Optionally, one or more of channels 328, 330, 334 may include a sealing feature adapted to form at least a partial seal between channel and a pipe portion extending therethrough. Suitable sealing features include, foam, sponge, brushes, bristles, flexible flanges, or other material capable of substantially filling the channel and form about a pipe portion extending therethrough. It should be appreciated that these sealing features may be taped, adhered or otherwise fixed to the enclosure.

For example, referring to FIG. 6a, 6c and 6e, a sealing member 337 is shown extending into a channel 334. The sealing member comprising a plurality of bristles that preferably intertwine, connect or otherwise substantially close the channel. Upon insertion of a pipe portion into the channel, the bristles move to substantially form about the pipe portion to form at least a partial seal between the interior portion of the enclosure and the surrounding environment. Preferably, the substantial forming of the bristles about the pipe portion is suitable for preventing a substrate position of corrosion-preventing type materials, may be placed within the enclosure, from exiting the enclosure through the openings formed by the channels.

Referring to another component, the base portion 316 may comprise generally of a square-shaped panel 338 having four joined sidewalls 340 extending perpendicular from the outer peripheral of the square-shaped panel 338 to form a cup-like member having an open end 342. Optionally, the interior portion of the sidewalls 340 are adapted to contact enclosure 312 so as to form a friction fit, though other attachment configurations are available as previously discussed.

When the base portion 316 is joined with the enclosure, it should be appreciated that the base portion may form or otherwise define a portion of the first and second opening 332, 336. Advantageously, as shown in FIGS. 6c and 6d, the base portion may be further be configured with one or more recess portions 343 formed in the sidewalls 340, which are adapted to provide improved sealing of the system 310 with a pipe portion extending threrethrough. It should be appreciated that the recess portions 343 may comprise a rigid portion of the enclosure that is similarly shaped to that of a pipe portion or alternatively may comprises a flexible elastic portion wherein upon placement about a pipe portion the material elastically or plastically deforms to form a recess in the base portion.

The recess portions are suitable for use in limiting the amount of corrosion material that may exit the enclosure. Alternatively, or in addition to the recess portions, the base portion may be configured with a sealing feature 337 as previously discussed to limit the amount of corrosion material from exiting the enclosure through the first and/or second opening.

Also, it is contemplated that the side walls 340 of the base portion may have a consistent or variable height. For example, as illustrated in FIG. 5, two of the four side walls 340 may be inclined to form a ramp like configuration, through other configurations are available.

Referring to another component of the fourth embodiment, the cover portion 314 comprises generally of a square-shaped panel 344 having four joined sidewalls 346 extending perpendicularly from the outer peripheral of the square-shaped panel 344 to form a cup-like member having an open end 348. Optionally, the interior portion of the sidewalls 340 contacts the cylinder 312 when joined with the cover portion 314 so as to form a friction fit, though other attachment configurations are available as previously discussed. It should be appreciated that the sidewalls 340, 346 may be variable in height or comprise of one or more recessed portion as discussed with the base portion.

It should be appreciated that the fourth embodiment may include any of the features included in the other embodiments contained herein. For examples, materials may be used to help prevent corrosion to the pipe portions and fixture, mounting or attachment features may be used to assemble or install the system seals or other fluid limiting devices, additional members or otherwise. Also, it should be appreciated that any of the features named above (or otherwise) in the fourth embodiment, or in any of the other embodiments, may be included with any other embodiment as taught, or suggested or described herein.

Furthermore, it should also be appreciated that any of the following additional components of the present and may be included with any of the embodiments contained herein.

With reference to FIGS. 6a-c, 7a-b, and 8, one method of installation of the system, along with associated tools, of the fourth embodiment is illustrated. The method is particularly useful in the protection of pipe portions and fixture located in a keyhole.

At the onset, the method includes the step of attaching the base portion 316 to a base portion installation tool 350 that is adapted for positioning and manipulation of the base portion below a pipe portion and fixture. Preferably, the base portion tool is further adapted to support the base portion during installation of other system 310 components.

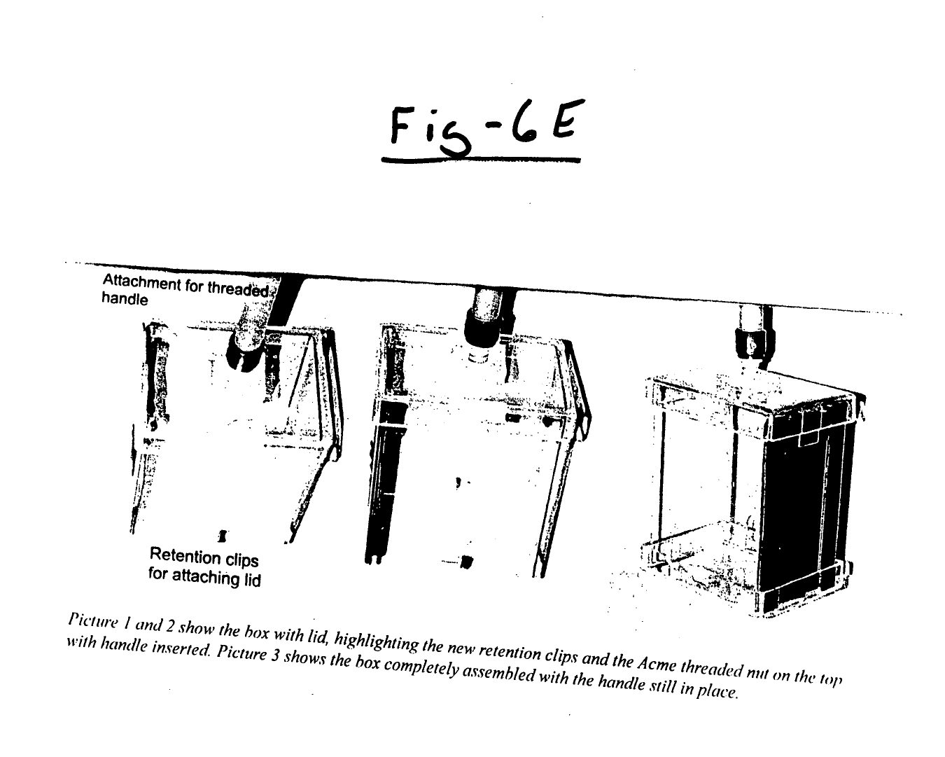

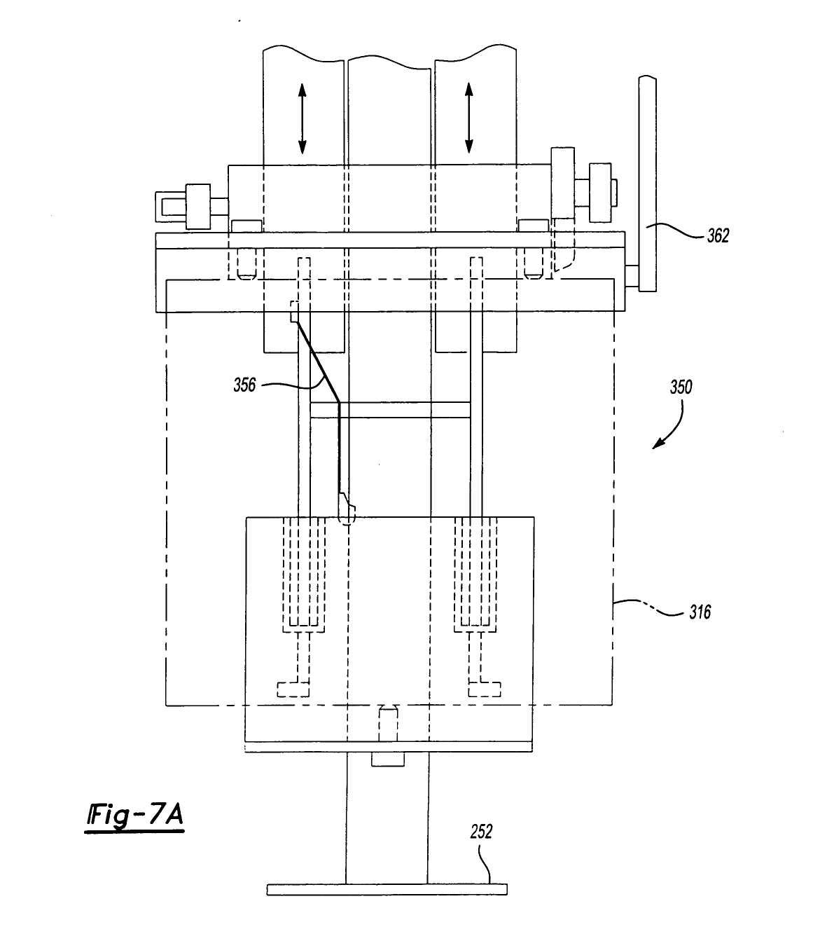

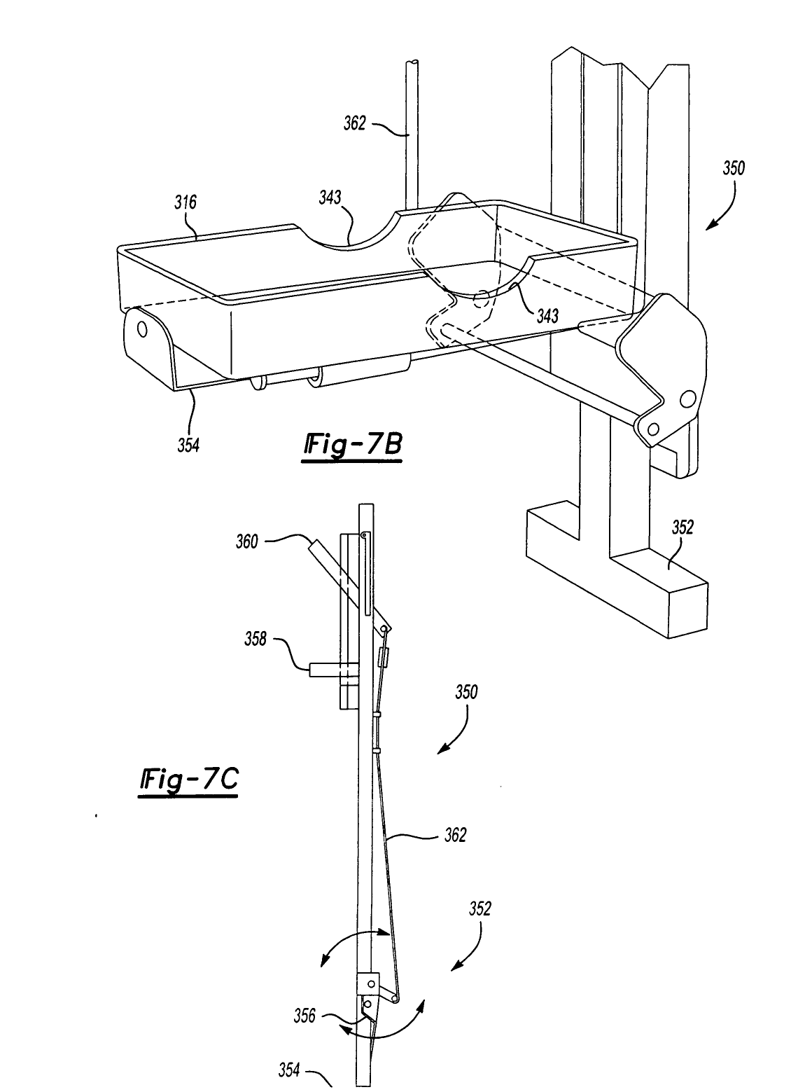

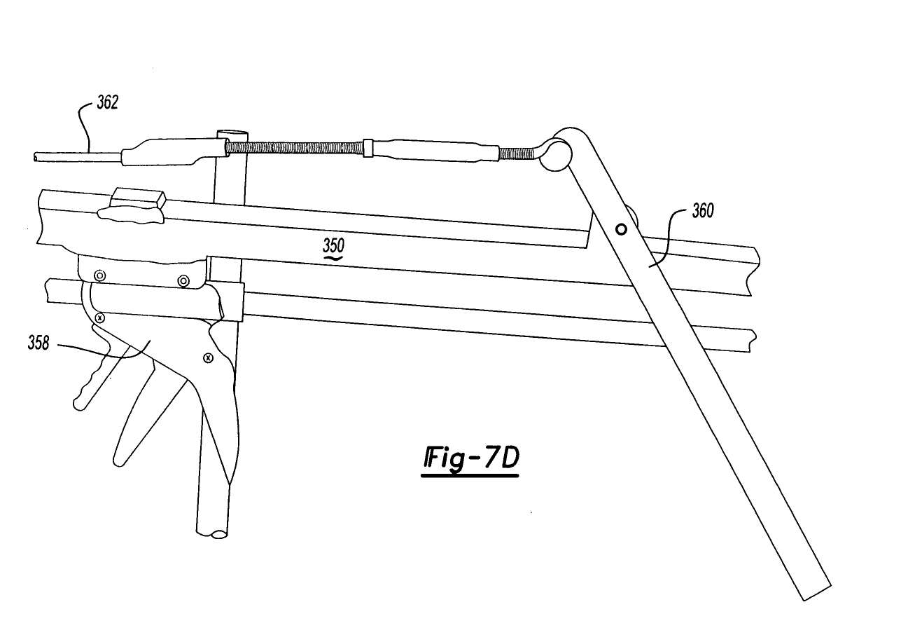

Referring to FIGS. 7a and 7d, examples of a base portion installation tool 350 is illustrated. The first end of the base portion tool 350 includes footing 352 adapted to support the base portion tool at the bottom of a keyhole formed in the ground. The second end of the tool includes one or more controllers for function of the tool, which preferably are located above the keyhole during installation. The base portion tool further includes a pivotally attached mount 354 that is also movable along the length of the tool. The mount includes a base portion attachment feature, which is adapted to secure the base portion to the mount. Through the pivotal attachment, the mount is configured to provide rotation of the base portion so that it is suitably position, under a pipe portion, for receiving the enclosure. As such, the mount is configured for rotation of between 0° to 180° and more preferably between 45° to 135°. In one preferred embodiment, the mount is configured for rotational movement of about 90°.

In the exemplary embodiment shown, securing of the base portion to the mount portion comprises a releasable friction fit controllable via a first controller (not shown) attached to the mount portion via a cable 356 or the like. Movement of the mount along the tool, as illustrated by the directional arrows, is achieved via a second controller, which in one exemplary embodiment comprises a ratcheting mechanism 358 or the like attached to mount via one or more members, which advantageously extend along the tool 350 and move with the mount as indicated by directional arrows. Rotational movement of the mount is achieved via a third controller, which in one exemplary embodiment comprises a lever 360 linkably attached to the mount via connecting bar 362. It should be appreciated that other forms of manipulation of the base portion are available and within the scope of the present invention. Also, it should be appreciated that the first second and third controller may be combined into one controller or separated into more than three controllers.

In operation, the method comprises attachment of the base portion to the mount, as demonstrated in FIG. 7a and as described above. The base portion installation tool is then lowered into the keyhole, via the first end. The mount is then rotated, similar to that shown in FIG. 7b, under a pipe portion and fixture using the second controller. Optionally, the mount is then moved away from the footing so that the base portion is positioned just below the pipe portion and fixture and the footing is supporting the base portion installation tool (e.g., the base portion installation tool is resting on the ground or otherwise).

The installation method of the system further includes the step of attaching the enclosure 312 to the base portion, preferably using an enclosure installation tool 364 that is adapted for positioning and assisting in the attachment of the enclosure to the base portion. The enclosure tool is adapted to attach to the enclosure such that the enclosure can be lowered into a keyhole and aligned with the base portion.

In one exemplary embodiment, as shown in FIG. 6a, the enclosure tool is configured with a clamping mechanism 366 at a first end of the enclosure tool and a controller (not shown) at a second end of the enclosure tool. The clamping mechanism is adapted to engage the enclosure for movement of the enclosure within a keyhole via the enclosure tool. The clamping mechanism includes a release mechanism (not shown) for disengaging the enclosure after attachment to the base portion.

In operation, the clamping mechanism engages the enclosure, preferably on the end opposite of the channels. The enclosure is lowered over a pipe portion and fixture such that the first and second channels are aligned with the pipe portion and the additional channel is aligned with the pipe portion extending from the fixture. The enclosure is then further lowered so that the pipe portions enter their respective channels. It should be appreciated that any existing sealing feature is displaced by the pipe portion but subsequently forms about the same thereby forming at least a partial seal between the interior portion of the enclosure and the surrounding environment. The lowing of the enclosure continues until the enclosure engages the base portion via the attachment feature or otherwise. The disengaging feature is then triggered resulting in the release of the enclosure.

Preferably, the installation method of the system further includes the step of filling the enclosure with a corrosion preventing material, as discussed herein. The material may be pumped, (e.g., mastic pump, mechanical pump, pneumatic pump or otherwise), gravity feed, combination thereof or otherwise placed in the enclosure. The material may be placed in the enclosure before or after the enclosure is lowered over a pipe portion and fixture. Optionally, the enclosure may be pre-filled with the corrosion preventing material before application or use of the enclosure. The enclosure may be pre-filled with the corrosion material alone or the enclosure may include a suitable carrier for the corrosion material. Examples of suitable carrier include sponges, felt, combinations thereof, or other loosely packed material. However, it also should be appreciated that a substantially non-porous carrier may be used as well. For example, it is contemplated that the non-porous carriers include a rupturable container (e.g., bag, balloon, or the like) adapted to ruptured upon compression forces from the pipe portion, fixture or otherwise (e.g., valve assembly) during placement of the enclosure onto the same.

Optionally, any of the components (particularly cap or cover portions) of any of the embodiments contained herein may include a fluid connector for receiving the anti-corrosion agent within the enclosure.

The installation method of the system further includes the step of attaching the cover 314 to a cover installation tool 368 and subsequently attaching the cover to the enclosure. Advantageously, the cover installation tool is adapted for positioning and assisting in the attachment of the enclosure to the base tool. As such, the cover installation tool is configured to attach to the cover such that the enclosure can be lowered into a keyhole and aligned with the enclosure.

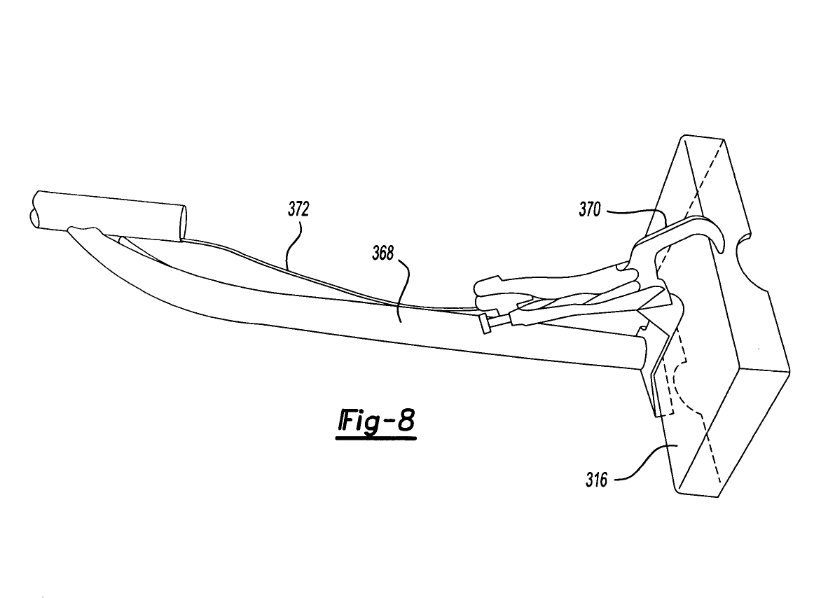

In one exemplary embodiment, as shown in FIG. 8, the cover installation tool is configured with a clamping mechanism 370 at a first end of the enclosure tool and a controller (not shown) at a second end of the cover installation tool. The clamping mechanism is adapted to engage the cover during movement of the enclosure within a keyhole via the cover installation tool. The clamping mechanism includes a release mechanism (not shown), linkably attached via a cable 372 or otherwise, for disengaging the enclosure after attachment to the base portion.

In operation, the clamping mechanism engages the cover, preferably on the exterior portion of the cover. The cover is lowered over the enclosure such that the cover is aligned with the enclosure. The cover is further lowered onto the enclosure such that the cover engages the enclosure. As previously mention, the engagement of the cover to the enclosure may include the attachment of the components via an attachment feature. The disengaging feature of the cover installation tool is then triggered resulting in the release of the cover.

Optionally, one or more of the components (e.g., base portion, enclosure or cover) may be integrally joined together or further separated into additional components. For example, it is contemplated that the cover may be integrally formed with the enclosure, similar to the configuration shown in FIG. 4a-4d. In such a configuration, advantageously, the corrosion prevention material is placed in the enclosure prior to installation of the enclosure onto the pipe portion and fixture. However it may be pumped into the enclosure as well using a suitable fluid connector.

It should be appreciated that any of the features of the fourth embodiment may be includes with any embodiment disclosed herein. Likewise, any of the features of the other embodiments or otherwise, may be included with the fourth embodiment.

It is contemplated that the embodiments contained herein may include additional features configured to prevent materials (e.g., water, dirt, rocks or otherwise) from entering the system. These features may include a sealing material, gaskets, hydrophobic material, reinforcing material, adhesives combinations thereof or otherwise, to assist in the restriction of foreign matter into the system. The application of these materials may be used on any portion of the system in which material may likely enter or exit the system. One preferred application of these materials is between the enclosure (e.g., cylinder or box structure) and a base portion, cover portion or both. It is contemplated that the system of the present invention may hermetically seal the enclosed pipe portion and fixture form the surrounding environment.

The rigidity of the enclosure may vary depending on the surrounding conditions. However, preferably the enclosure is rigidly or semi-rigidly configured to resist forces typically encountered in underground utility applications (e.g., pressure due to applied layers of dirt placed there upon, jarring force due to excavating machines, internal pressures originating from an enclosed pipe, erosion or otherwise). More preferably the enclosure is rigid and can resist the above mentioned forces or otherwise without failure or substantial deformation such that the integrity of the pipe portions and fixture is not compromised (e.g., the application of forces against the enclosed pipe portions and fixture).

Suitable materials contemplated for the present system (including enclosure, cover and base portions) includes metals, plastics, rubber or otherwise. Preferred material includes materials that are substantially resistant to sparks and/or corrosion. A preferred material includes a rigid material, which are both spark and corrosion resistant. Of course, it should be appreciated that the one or more of the components of the system may comprise materials that are dissimilar. Advantageously, any of the system components may be manufactured using common forming techniques such as molding, casting, stamping or otherwise.

It is also contemplated that the enclosure of the present invention comprises a color, which assists an excavator in finding the enclosure prior to damage to the enclosed pipe portions and fixture located therein. Preferably, the color of the enclosure contrasts the colors typically found during excavation (e.g., brown or other earth tone colors). Preferred colors of the present enclosure include bright or florescent colors. Examples of such colors include: yellow, green, blue, orange, red, white, black, combinations thereof or otherwise. One preferred color includes a color corresponding to a color used in a specific industry to indicate the type of utility (e.g., yellow for natural gas). However, it is also contemplated that the enclosure may be transparent

Furthermore, it is contemplated that for any of the embodiments contained herein, one or more additional layers may be applied to the enclosure (e.g., cylinder or box structure, cover portion or base portion) to enhance the performance of the enclosure. Such additional layers may include spark resistance materials, anticorrosion materials, adhesives, reinforcing materials, pigmentation or otherwise.

An additional feature that is contemplated with the embodiments contained herein includes a locking mechanism, such as an attachment feature as previously discussed herein. The locking mechanism may permanently or temporarily prevent the components of the system from separating (e.g., the cylindrical or box structure from the base or cover portion). Furthermore, suitable adhesive may alternatively or in conjunction with, be used to attach components of the system.

Likewise, it is also contemplated that a sealing agent may be use in combination with the adhesive or the adhesive comprises sealing characteristics. As such, a sealing agent may be used about the entirety of the joining surfaces between the cylinder or box structure and the base, cover or both portions to substantially seal the enclosed pipe portion and fixture and optionally create a substantially hermetic seal from the surrounding environment.

Yet another additional feature is a suitable fluid connector, preferably located on a cover portion or cylinder or box structure portion, having opening for receiving corrosion preventing material within the system. It is contemplated that the connector is configured to matingly link with a suitable delivery means for the introduction of material into the enclosed system. As previously mentioned, preferably the material comprises characteristics which assisting in preventing corrosion to the pipe portion and fixture.

Suitable materials that may be used to coat and protect the pipe portions and fixture include hydrophobic materials. Preferably, the material is adapted to displace water from a pipe portion and/or form a substantial seal between the pipe portion and the surrounding environment. A preferred material has a material viscosity such that is adheres to pipe portion and fixture but is still flowable to allow the material to fill the cavity, wherein the cavity having the material is substantially free of voids. However, the material may be pourable material at a first temperature and be substantially solidified at a lower second temp. By example, the material may comprise or otherwise include wax.

Another suitable material includes petroleum or a petroleum byproduct, optionally; the petroleum product includes a wax. Suitable generic petroleum products include oils, grease or other lubrication type products. More specific examples of suitable material include petroleum, wax-based product sold by Trenton Corporation of Ann Arbor, Mich. under the trade names Graycoat, Temcoat and Fill Coat No. 6. However, one preferred agent is petroleum, wax-based product sold by Trenton Corporation of Ann Arbor, Mich. under the trade name Wax-Tape Primer. The Wax-Tape Primer advantageously adheres to pipe portions and fixtures but still remains pourable or is otherwise capable of filling the cavity leaving little to no voids or air pockets.

Other examples of a suitable materials and delivery methods thereof which may be used in conjunction with the present invention can be found in commonly owned U.S. Pat. No. 4,469,469 herein incorporated by reference.

Alternatively, or in conjunction therewith prior to the enclosure, the pipe portion and fixture may be wrapped with a protective coating. A first example of a preferred protective material is a wrapping material configured to cover the pipe portion and fixture. Preferably, the wrapping material comprises a water resistant material and more preferably is configured to prevent water or moisture from contacting the pipe portions or valve assembly when wrapped around the same. These wraps may include a petroleum product and/or wax.

Examples of suitable wrapping material that may be used in conjunction with the present invention can be found in commonly owned U.S. Pat. Nos. 5,540,985, 3,625,259 and 3,525,656 herein incorporated by reference.

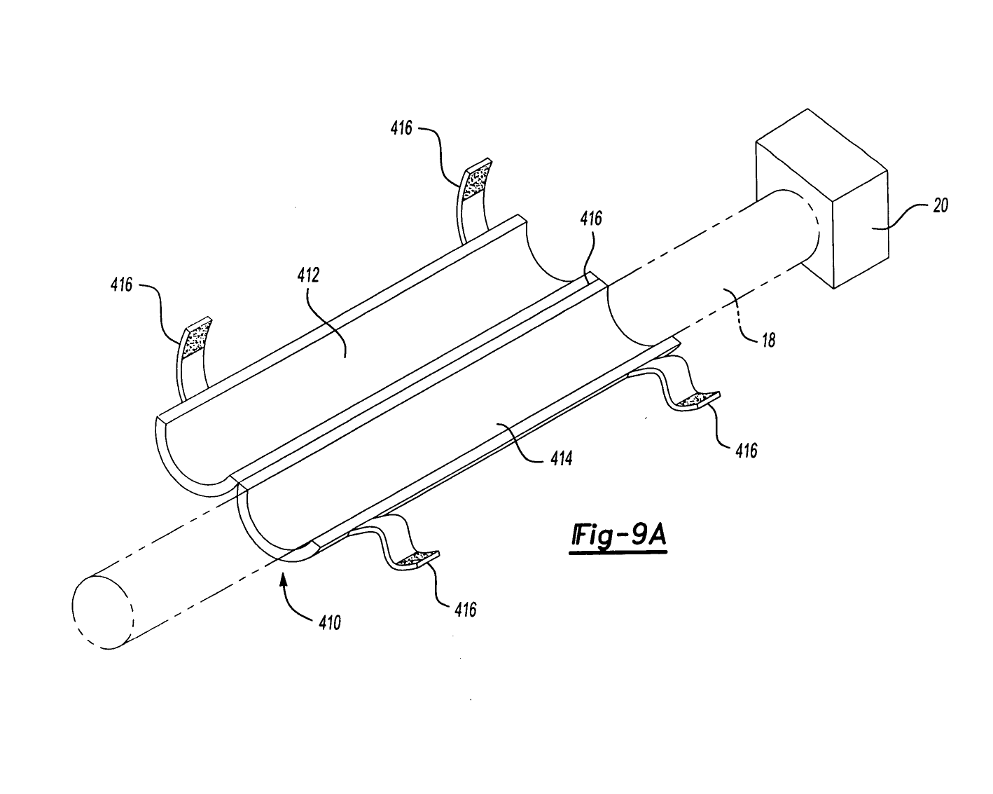

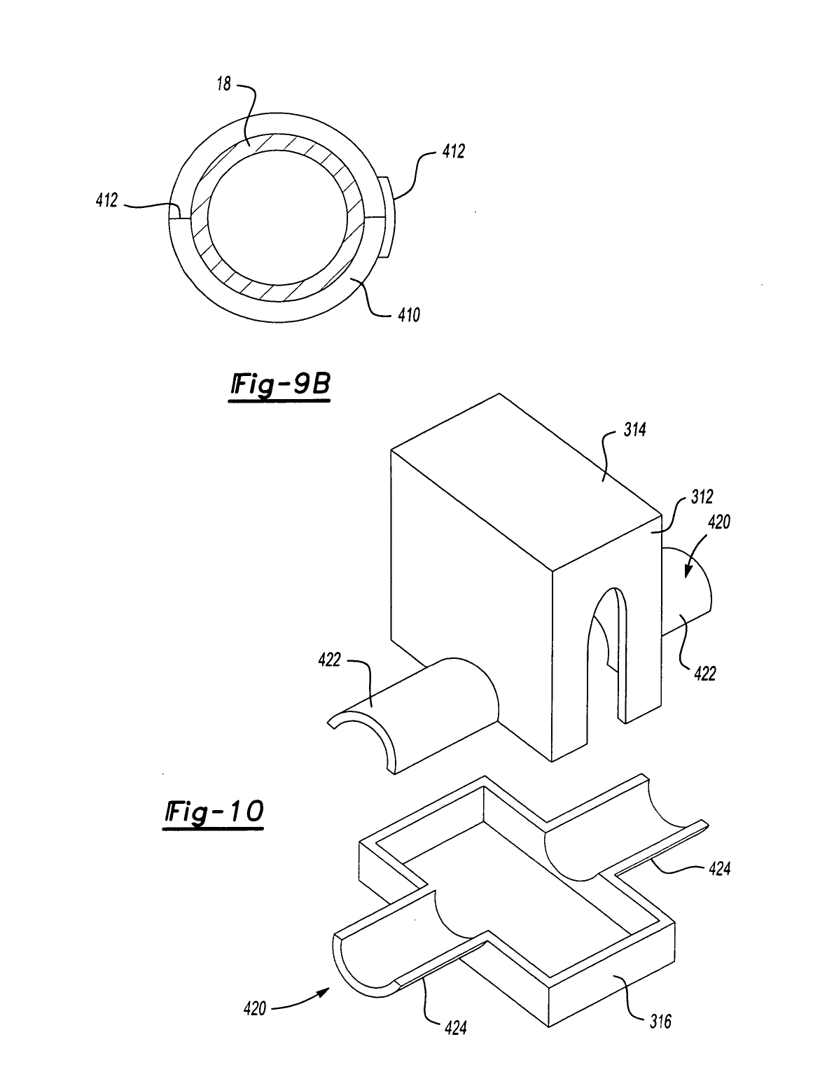

In any of the embodiment disclosed, it should be appreciated that additional protective layers may be used to provide additional protection to pipe portions, particularly pipe portions extending from fixtures such as fixture. In one example, referring to FIGS. 9a and 9b, a protective sleeve 410 is provided which is adapted to wrap about at least a portion of a pipe portion 18. In that embodiment, the protective sleeve comprises a first and second half, 412, 414, which are adapted to be joined together to form the protective sleeve. As such, preferably the protective sleeve includes one or more attachment features 416 for joining or maintaining attachment of the first and second half. Suitable attachment features include, but are not limited to: hinges (ether mounted or living hinges), adhesives, snap fits, hook and latch configurations, straps or otherwise.

Preferably, the protective sleeve is used with the protective system of the present invention. More, preferably, the sleeve is adjacently placed to one of the protective systems of the present invention such that little to no gap exist therebetween.

In another example, referring to FIG. 10, another protective sleeve 420 is provided, which again is adapted to wrap about at least a portion of a pipe portion 18. However, in this example, the protective sleeve is shown as an integrated member to the fourth embodiment of the present invention, though it may be used with any of the embodiments of the present invention. The protective sleeve comprises a first half 422 extending from the enclosure 312 and a second half 424 extending from the base portion 313. Upon joining of the enclosure and the base portion, the first and second half form the protective sleeve 420.

It should be appreciated that the protective seal may comprise of more or less than two components. Also, it should be appreciated that the protective sleeve may include a corrosion protection material as disclosed herein.

The protective sleeve may comprise any suitable material for providing protection to the pipe portion. Suitable materials include metal, plastic, glass or otherwise. However, preferably, the material is plastic or is of the same material as the protective pipe and fixture.

In view of the foregoing discussion, the present invention provides a system and method for providing a rigid protective enclosure for protecting one or more enclosed pipe portions and fixture from surrounding applied forces. In addition, the present invention further provides a rigid enclosure adapted to sealably enclose one or more pipe portions and fixture from the surrounding environment, particularly water and other potentially corrosive fluids. Advantageously, the present invention provides these benefits while being spatially restricted during installation, as typically encountered when using keyhole technology.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only four of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A system for the protection of pipe portion and fixtures attached thereto, the system comprising:
a first member including an enclosure forming a cavity, the first member being defined by one or more wall portions extending between a first end and a second end of the first member, the one or more wall portions defining at least a portion of a first opening and a second opening both of which extend into the cavity;
a base portion adapted to engage the first or second end of the first member and define at least a portion of the first, second or both openings.

2. The system of claim 1, further comprising a cap portion located at an opposite end to the base portion, wherein the cap portion comprises an integrated component of the first member or the cap comprises a separate component adapted to engage the first or second end of the first member opposite the base portion.

3. The system of claim 2, wherein the cap portion includes an engagement feature for attachment to a tool having a corresponding engagement feature thereto.

4. The system of claim 2, wherein the cap portion includes a fluid conduit for receiving fluid into the cavity of the first member

5. The system of claim 1, wherein the first opening, the second opening or both extend generally perpendicular through the one or more side walls forming the first member.

6. The system of claim 5, wherein the first opening or second opening extend completely through the first member

7. The system of claim 1, wherein the first and second opening formed by the first member and base portion is arcuate about at least 180°.

8. The system of claim 1, further comprising an attachment feature adapted to maintain the position of the base portion relative to the first member.

9. The system of claim 1, wherein the base portion include an engagement feature for attachment to a tool having a corresponding engagement feature thereto.

10. The system of claim 1, further including an anticorrosion agent located within the cavity.

11. The system of claim 10, wherein the anticorrosion agent includes petroleum wax.

12. The system of claim 1, further including one or more additional features or members for defining the first opening, second opening or both.

13. The system of claim 12, wherein the one or more additional features or members comprise foam, sponge, brushes, bristles, flexible flanges or combinations thereof.

14. The system of claim 1, further comprising a second member including an enclosure forming a cavity, the first member being defined by one or more wall portions extending between a first end and a second end of the first member, the one or more wall portions defining at least a portion of the first opening and the second opening, wherein the second member resides within the first member and is configured in shape to rotate within the first member.

15. A system for the protection of pipe portion and fixtures attached thereto, the system comprising:
a first member including an enclosure forming a cavity, the first member being defined by one or more wall portions extending between a first end and a second end of the first member, the one or more wall portions defining at least a portion of a first opening and a second opening both of which extend generally perpendicular with the wall portions and into the cavity;
a base portion adapted to engage the first or second end of the first member and define at least a portion of the first, second or both openings, wherein the base portion, first member or both include an attachment feature for attachment to the other of the base portion or first member;
a cap portion adapted to engage the first or second end of the first member opposite the base portion; and
an anticorrosion agent located within the cavity and substantially filling any void therein, wherein the anticorrosion agent includes a petroleum wax.

16. A method of protecting an underground pipe portion and fixture attached thereto, the method comprising the steps of:
providing a first pipe portion having a fixture attached thereto and second pipe portion extending from the fixture;
placing a base portion below the first and second pipe portion and fixture;
enclosing the first pipe portion, second pipe portion and fixture with an enclosure, the enclosure comprising:
one or more wall portions extending between a first end and a second end of the first member, the one or more wall portions defining at least a portion of a first opening and a second opening both of which extend into the cavity;
wherein the first pipe portion extends through the first opening, the second pipe portion extends through the second opening and the fixture resides substantially within the cavity; and
attaching the enclosure to the base portion.

17. The method of claim 16, further comprising the step of placing an anticorrosion agent within the cavity to coat the first pipe portion, second pipe portion, fixture or combinations thereof.

18. The method of claim 17, wherein the anticorrosion agent fills the cavity such that the cavity is substantially free of voids of anticorrosion agent.

19. The method of claim 16, further comprising the step of accessing at least one of the first pipe portion or second pipe portion by forming a keyhole within a ground surface.

20. The method of claim 19, wherein the base portion and enclosure include engagement features for attachment to tools for lowering and manipulation of the base portion and enclosure within the formed keyhole.
